(19) United States
(12) Patent Application Publication
(10) Pub. No.: US 2009/0298038 A1
(43) Pub. Date: Dec. 3, 2009

(54) Method and System for Scenario Based Training with Consequences

(75) Inventor: Tracey Anne Mitchell, Bungendore (AU)

Correspondence Address: THE WEBB LAW FIRM, P.C., 700 KOPPERS BUILDING, 436 SEVENTH AVENUE, PITTSBURGH, PA, 15219, US

(73) Assignee: CHOCDOG PTY LTD, Queanbeyan (AU)

(21) Appl. No.: 12/327,197

(22) Filed: Dec. 3, 2008

(30) Foreign Application Priority Data
May 27, 2008 (AU) 2008902666

(51) Int. Cl. G09B 7/00

(52) U.S. Cl. 434/350; 434/362; 434/353

(57) ABSTRACT

A scenario based training or assessment method and/or system including user consequences. The method being performed on a processing system and including providing the user with scenario information and providing the user with a question and a plurality of answers. The user provides a selected answer to be received by the processing system, the selected answer being selected from the plurality of answers by the user. The user is then provided with a consequence based on the selected answer. If the user selects an incorrect answer to the question in a particular scenario, a sequence of multiple scenarios loops back and returns to the particular scenario at a later point in time.

### TECHNICAL FIELD

The present invention generally relates to scenario based training of users, and more particularly to a method and/or system for scenario based training with consequences, for example embodied as a simulator for training or assessing a user at a terminal or other processing system based on a series of scenarios and questions presented to the user.

### COPYRIGHT NOTICE/PERMISSION

A portion of the disclosure of this patent specification contains material that is subject to copyright protection. The copyright owner has no objection to the facsimile reproduction by anyone of the patent specification or parts thereof as it appears in the file or records of a Patent Office, but otherwise reserves all copyrights whatsoever.

### BACKGROUND

Systems for simulated training are presently known that allow a user to provide an answer to a question and then provide feedback to the user at the end of a series of questions, for example following simple analysis of the number of correct versus incorrect answers.

However, presently known training simulators do not provide consequences to a user as a result of the user answering a question in a scenario. This means the user is not exposed during the training to any “cause and effect” due to the user's answers.

The applicant has identified that presently known training simulators do not generally result in effective retention of knowledge or learning by a user. When a user participates in presently known training simulators the user is typically provided with information, a set of questions, asked to select answers, and then possibly receives feedback dependant upon the user's answers. There are no consequences in relation to the user's selected answers, which leads to limited retained knowledge.

There is a need for a method, system, computer program product, article and/or computer readable medium of instructions which addresses or at least ameliorates one or more problems inherent in the prior art.

The reference in this specification to any prior publication (or information derived from the prior publication), or to any matter which is known, is not, and should not be taken as an acknowledgment or admission or any form of suggestion that the prior publication (or information derived from the prior publication) or known matter forms part of the common general knowledge in the field of endeavour to which this specification relates.

### BRIEF SUMMARY

The present invention provides a method, system, computer program product, article and/or computer readable medium of instructions for scenario based training with consequences. The present invention can be embodied as a training or assessment simulation or simulator and can be used to assist in the education, training and/or assessment of one or more users to satisfactorily perform a task or activity.

According to a first broad form, there is provided a method of providing scenario based training or assessment of a user, the method performed on a processing system and including the steps of: providing the user with scenario information; providing the user with a question and a plurality of answers; receiving a selected answer, the selected answer being selected from the plurality of answers by the user; and, providing the user with consequence information based on the selected answer.

According to a second broad form, there is provided a system for providing scenario based training or assessment of a user, the system including: an output device to provide the user with scenario information and to provide the user with a question and a plurality of answers; an input device to receive a selected answer, the selected answer being selected from the plurality of answers by the user; and, wherein, the output device provides the user with consequence information determined by at least one processor based on the selected answer.

According to a third broad form, there is provided a computer program product for providing scenario based training or assessment of a user, the computer program product able to be executed on a processing system and to: provide the user with scenario information; provide the user with a question and a plurality of answers; receive a selected answer, the selected answer being selected from the plurality of answers by the user; and, provide the user with consequence information based on the selected answer.

### BRIEF DESCRIPTION OF FIGURES

Example embodiments should become apparent from the following description, which is given by way of example only, of at least one preferred but non-limiting embodiment, described in connection with the accompanying figures.

FIG. 1 illustrates a functional block diagram of an example processing system that can be utilised to embody or give effect to a particular embodiment;

FIG. 2 illustrates a block diagram of an example training simulator system;

FIG. 3 illustrates a flowchart of the general global flow of data for an example training module or scenario of the training simulator system;

FIG. 4 illustrates an example user logon screen;

FIG. 5 illustrates an example screen presented to a user while undertaking scenario based training; and,

FIG. 6 illustrates a flow diagram of an example method of providing scenario based user training or assessment with consequences.

### PREFERRED EMBODIMENTS

The following modes, given by way of example only, are described in order to provide a more precise understanding of the subject matter of a preferred embodiment or embodiments.

In the figures, incorporated to illustrate features of an example embodiment, like reference numerals are used to identify like parts throughout the figures.

Consequence based training described herein can be considered to be based on “cause and effect”. In a particular embodiment, the decision a user makes, that is the answer the user provides, directly results in a particular consequence occurring, and as a result, has an effect, whether on the user making the decision, or on others.

In one particular form, the system and/or method is embodied as a training simulator application operating on a processing system or other form of user terminal (e.g. computer, PDA, mobile telephone, etc.). As an example overview, in the training simulator there is initially provided a logon screen presented to a user intending to undergo training or testing. After successful logon, the user can be exposed to any desired or pre-defined number of a plurality of different scenarios which are to be played out by the user.

In an example form, for one or more scenarios there can be provided:
1. a scene or scenario set up or background;
2. a question or query;
3. a number of multiple choice answers, for example 2, 3, 4, 5, etc. potential answers;
4. for each answer there is a consequence;
5. for each consequence there may be provided feedback;
6. for one or more scenarios there may be additional information relating to what knowledge the scenario was trying to impart to the user;
7. navigation to another or next scenario.

An advantage of the training simulator is the incorporation of “cause and effect”, that is a consequence, which is preferably, though not necessarily, followed by feedback presented to the user. If a user selects an inaccurate answer, then a consequence is presented to the user.

As a specific illustrative example, if a user chooses not to challenge someone in a “tailgating through a security barrier” scenario, the consequence may be that a member of staff is assaulted at her desk by her estranged husband, A user can be provided with notification of the consequence via the simulator, optionally followed by appropriate feedback.

Preferably, if a user selects an incorrect answer or response in a particular scenario, the sequence of multiple scenarios loops back and returns to the particular scenario at a later point in time, When the user is again presented with the same particular scenario the answer previously given by the user can be removed so that the user is now presented with a reduced choice of potential answers. This “looping” back to a particular scenario can continue until the user selects the correct answer or response, and the user is presented with an associated consequence for the correct answer or response. The user can then also receive feedback and continue progress in the training simulator.

After all or a defined or preset number of scenarios are completed, the user may be presented with a “certificate” screen. This screen allows a user to print or save a certificate of completion if the user so chooses. On completion, notification is preferably automatically provided to a responsible person or section, for example a company's human resources manager or section. Notification could be by way of email and/or updating a database.

The training simulator system includes input devices, data processing and output devices. Users log onto the system and are presented with a range of predefined scenarios. For each scenario the user inputs data via the input device. The input data is interpreted by a software application executing on or remote to the system and applied to a set of functional rules defining the logic of the software application. If the input data is determined to be a correct or a positive response this is reflected by output data presented to the user by the output device. If the input data is determined to be an incorrect or a negative response the software application causes the output device to present the user with output data representative of a causal outcome determined by the software application using the function rules.

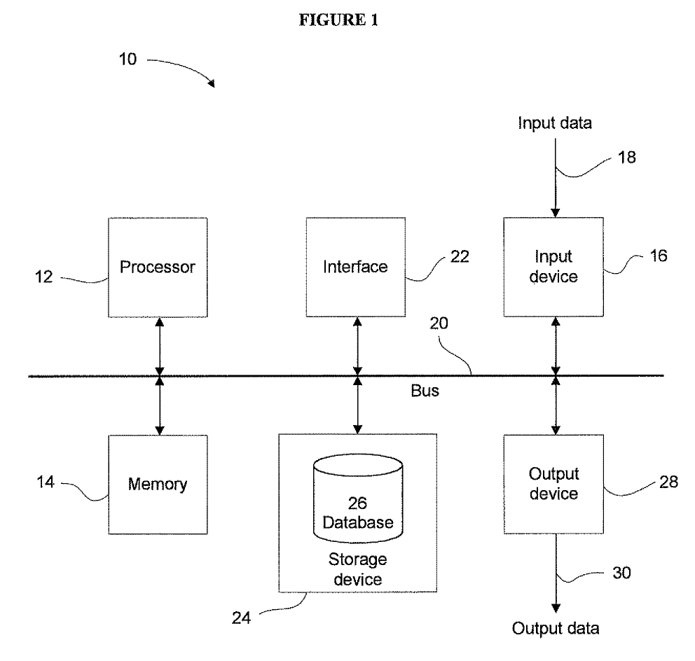

A particular embodiment of the present invention can be realised using a processing system, an example of which is shown in FIG. 1. The training simulator can be in the form of a software application that executes on the processing system. In particular, the processing system 10 generally includes at least one processor 12, or processing unit or plurality of processors, memory 14, at least one input device 16 and at least one output device 18, coupled together via a bus or group of buses 20. In certain embodiments, input device 16 and output device 18 could be the same device. An interface 22 can also be provided for coupling the processing system 10 to one or more peripheral devices, for example interface 22 could be a PCI card or PC card. At least one storage device 24 which houses at least one database 26 can also be provided. The memory 14 can be any form of memory device, for example, volatile or non-volatile memory, solid state storage devices, magnetic devices, etc. The processor 12 could include more than one distinct processing device, for example to handle different functions within the processing system 10.

Input device 16 receives input data 28 from a user and can include, for example, a keyboard, a pointer device such as a pen-like device or a mouse, audio receiving device for voice controlled activation such as a microphone, data receiver or antenna such as a modem or wireless data adaptor, data acquisition card, etc. Input data 28 could come from different sources, for example keyboard instructions in conjunction with data received via a network. Output device 18 produces or generates output data 30 and can include, for example, a display device or monitor in which case output data 30 is visual, a printer in which case output data 30 is printed, a port for example a USB port, a peripheral component adaptor, a data transmitter or antenna such as a modem or wireless network adaptor, etc. Output data 30 could be distinct and derived from different output devices, for example a visual display on a monitor in conjunction with data transmitted to a network. A user could view data output, or an interpretation of the data output, on, for example, a monitor or using a printer. The storage device 24 can be any form of data or information storage means, for example, volatile or non-volatile memory, solid state storage devices, magnetic devices, etc.

In use, the processing system 10 is adapted to allow data or information to be stored in and/or retrieved from at least one local and/or remote database. The interface 22 may allow wired and/or wireless communication between the processing unit 12 and peripheral components that may serve a specialised purpose. The processor 12 receives instructions as input data 28 via input device 16 and can display processed results or other output to a user by utilising output device 18. More than one input device 16 and/or output device 18 can be provided. It should be appreciated that the processing system 10 may be any form of terminal, server, specialised hardware, or the like.

The processing system 10 may be a part of a networked communications system, for example the Internet or a WAN. Input data 28 and output data 30 could be communicated to other devices via a network. The transfer of information and/or data over the network can be achieved using wired or wireless communications means. A server can facilitate the transfer of data between the network and one or more databases. The server and one or more databases provide an example of an information source. The network may be or form part of other communication networks, such as LAN, WAN, ethernet, token ring, FDDI ring, star, etc., networks, or mobile telephone networks, such as GSM, CDMA or 3G, etc., networks, and may be wholly or partially wired, including for example optical fibre, or wireless networks, depending on a particular implementation.

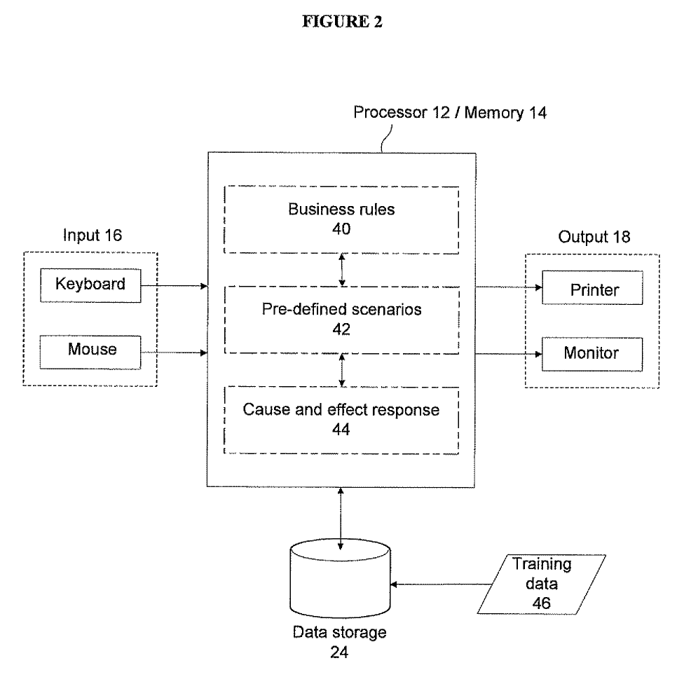

Referring to FIG. 2 there is illustrated a block diagram of an example training simulator system including the input device 16, the output device 18 and the data storage 24. The processor 12 executes, or the memory 14 stores for the processor 12, business rules 40 (i.e. functional logic of the software application), pre-defined scenarios 42 and “cause and effect” (i.e. consequence) responses 44. Training data or information 46 is supplied to the data storage 24 as required, for example when new training scenarios are developed.

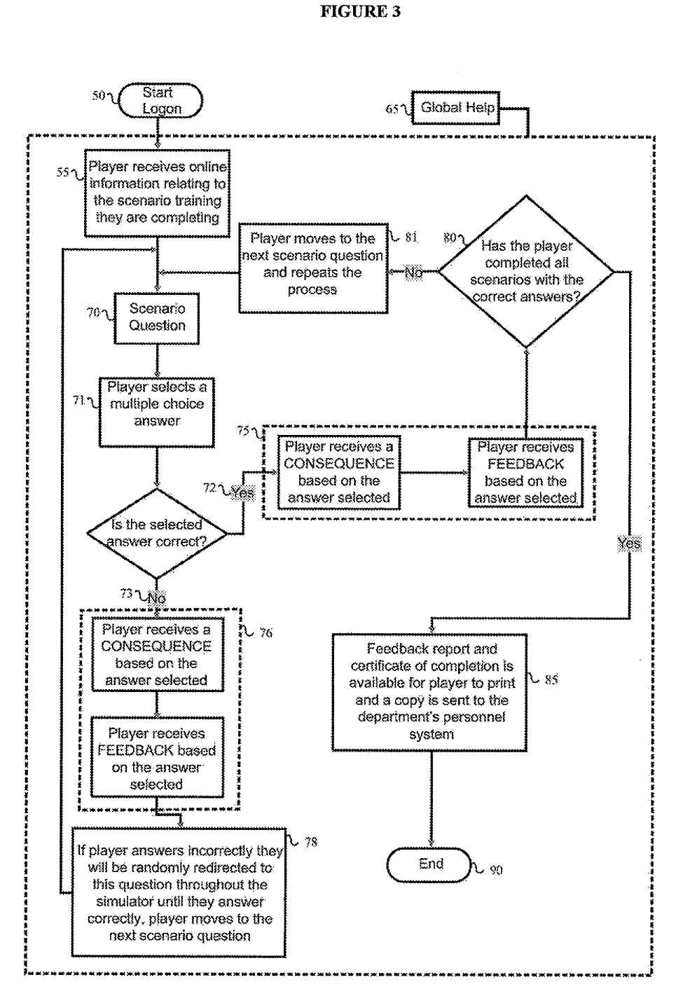

Referring to FIG. 3 there is illustrated a flowchart of the general global flow of data for an example training module or scenario of the training simulator system. At logon step 50 a user provides identifying or authorisation information to the training simulator system. Preferably, a user supplies his or her first and last names and unique identifying details, for example, a unique identifier code previously allocated to the user and possibly a security level. After logon the user has access to a global help 65 facility that can assist the user in using the training application. The user is directed to or presented with an information screen 55 where they are given scenario based information about the topic, for example general background information setting a scene. After reading this information the user is directed to or presented with a scenario question 70. The scenario question 70 can be framed or provided with additional scenario information or background. Preferably the user is also presented with a plurality of potential answers, for example in a multiple choice format. At step 71, the user selects one of the answers as a response to the scenario question. A determination is then made by the application if the response is correct or incorrect.

If the response is correct step 72 occurs and the user is presented with a consequence at step 75 which is determined by the applications business or functional rules 40. If the response is incorrect step 73 occurs and the user is presented with a different consequence at step 76 which is also determined by the applications business or functional rules 40.

At steps 75 or 76 the user also can be presented with feedback, and assessed against the number of successfully completed scenarios at step 80. If the user has completed all scenarios successfully then at step 85 the user is presented with summary feedback and an ability to print or save a certificate of completion. The training simulation would then end at step 90. A copy of an identification for the certificate of completion can be electronically sent to a selected or defined email address and the training is deemed to have been completed by the user.

If the user has not completed all scenarios as determined at step 80 then the user is presented with another scenario at step 81. The scenario presented to the user can be the next in a series of scenarios or randomly selected.

If the user selects an incorrect response resulting in step 73, and after the user has been presented with an associated consequence and feedback at step 76, then at step 78 the user is presented with another scenario similarly to step 81. However, the user is redirected (either deterministically or randomly) to the same scenario question 70 at some later time in the training simulation until the user has correctly answered the scenario question 70.

The business rules 40, i.e. the application program's functional rules, represent the logic flow of the application program. Generally, the business rules 40 determine the flow of scenarios, questions, consequences and feedback based on the user's answers as follows. For each scenario a user is presented with information, a question and potential responses. Dependant on the response given, the user is presented with a consequence, preferably followed by feedback. Dependant on whether the user's response is correct or incorrect, the user moves through the sequence of information and questions. If the user provides an incorrect response, the scenario and question that was not answered correctly loops back into the sequence of scenarios and questions at a later stage. The incorrect answer is preferably removed from the potential answers when next presented to the user. This looping continues until there is only one answer left for a user response, being the correct one, at which time the looping ceases. Once all scenarios and questions required to be dealt with by the user have been answered correctly the user is presented with a final screen which contains a certificate of completion which the user can print or save if desired.

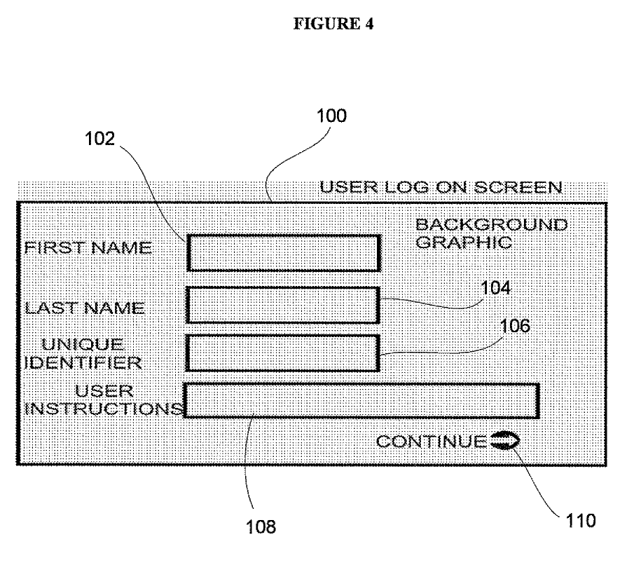

Referring to FIG. 4 there is illustrated an example logon screen 100 able to be presented to the user. Input field 102 requires the user's first name, input field 104 requires the user's last name, input field 106 requires an unique identifier for the user, and in input field 108 the user can submit any specific instructions or codes that may determine the type, number, field, area, difficulty level, etc. of the training scenarios presented to the user, for example, resulting in pre-defined scenarios based on airport security as opposed to office security being presented to the user. Icon 110 can be selected by the user to submit the logon information.

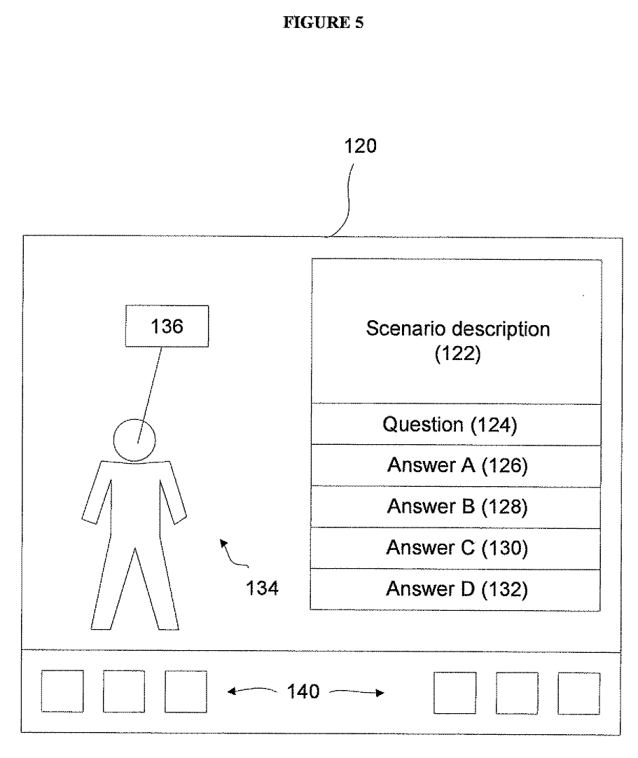

Referring to FIG. 5 there is illustrated an example screen 120 presented to a user while undertaking scenario based training. Background information or a scenario specific situation 134 (which can be one or a combination or visual, image video, text and/or audio information) is displayed to the user. Additional descriptive text which provides a short overview or description of the scenario and places a question in context can be displayed to the user in window 122. Dialog box 136 associated with a human role-playing character might be displayed as part of scenario specific situation 134. Dialog box 136 can be used to further create the scenario presented to the user and place the question in context.

Alternatively or additionally audio may automatically play, or the user could be provided with the facility to click on dialog box 136 to play the audio that reflects the dialog in dialog box 136. The question or query posed to the user can be displayed in window 124. A series of potential answers is displayed to the user as answers 126, 128, 130 and 132. Any number of answers can be utilised but preferably four potential answers are displayed. Icons 140 allow the user to perform various actions by clicking or activating one of icons 140. For example icons 140 could allow the user to access global help 65, display an overview of total scenario progress, save the user's current position, print a screen, delete or exit the current scenario training, open a new scenario training, etc. The user can click on or otherwise activate (for example by pressing an associated number or letter on a keyboard) a specific answer 126, 128, 130 or 132 to select and submit that answer to the question 124.

The specific layout for presenting scenario information, questions and answers is variable and a wide variety of different formats can be utilised. After selecting an answer a user is then presented with a screen containing consequence information. The consequence information can be presented in a wide variety of formats, for example including text, image, video and/or audio information. The consequence information relays to the user a real-life consequence of what could occur if the user had followed the selected answer in practice. A subsequent feedback screen may also be provided to the user which contains feedback information in a wide variety of formats, for example including text, image, video and/or audio information. The user would then be returned to a scenario screen such as scenario screen 120.

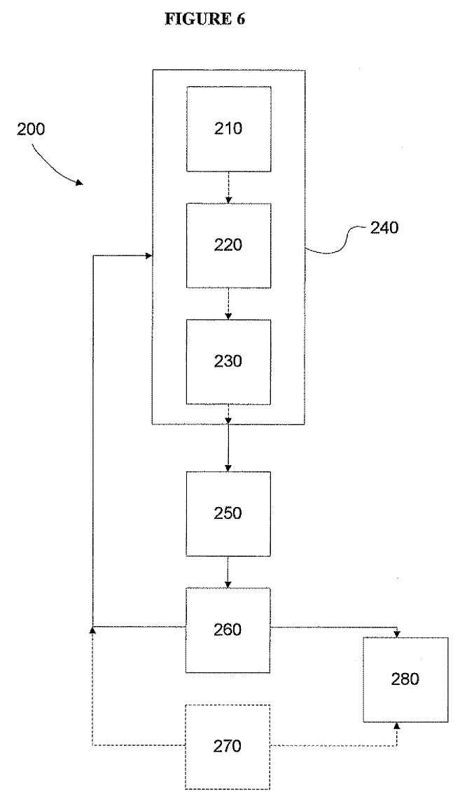

Referring to FIG. 6 there is illustrated a general flow diagram of an example method 200 of providing scenario based user training or assessment with consequences. The method 200 includes providing the user with scenario information at step 210, providing the user with a question at step 220, and providing the user with a plurality of answers at step 230. The scenario information, question and plurality of answers could be provided as a single step 240. At step 250 a selected answer is obtained from the user, the selected answer being selected from the plurality of answers by the user. At step 260 the user is provided with a consequence based on the selected answer. Optionally the user can also be provided with feedback at step 207. After step 260 or 270, the scenario based training will either end at step 280 (if all scenarios have been completed) or present a different scenario to the user returning to step 210 (or 240).

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention.

### Schedule—Specific Scenario and Consequence Examples

This schedule includes further specific but non-limiting examples providing a more detailed discussion of a particular example scenarios, questions, answers, consequences and feedback. The examples are intended to be merely illustrative and not limiting to the scope of the present invention.

### Login

| Scene | | |
|---|---|---|
| ID | Content | Scene details |
| 3 | Welcome! Please enter your details. | Background is your desk - |
| | First name: {firstname text field} | having arrived here |
| | Last name: {lastname text field} | through the security gates. |
| | Security clearnance name: {secID | Logon screen comes up on |
| | text field} | your computer screen. You |
| | | need to logon here to gain |
| | | access. |

### Security Clearance Advice

| Scene ID | Content | Scene details |
|---|---|---|
| 4 | Dated today | Scene is |
| | (badged with Department name) (level | your desk. |
| | triggered by logon screen) | You receive |
| | Commonwealth Crest | a letter which |
| | Dear (name of log on screen) | you read. |
| | Security Clearance Advice | |
| | I am writing to advise you that the | |
| | Department has granted your (Level of | |
| | clearance linked from your logon) level | |
| | security clearance effective immediately. | |
| | This clearance is valid for five years | |
| | from this date. | |
| | Your clearance permits you to have access | |
| | to information, areas and systems classified | |
| | up to and including this level - where you | |
| | need such access to perform your duties or | |
| | fulfil your contract. Your clearance does | |
| | not give you a general right of access to all | |
| | information, areas and systems classified at | |
| | this level and below. | |
| | Once you start working for the Department, | |
| | you are required to undertake the following | |
| | steps in order to retain your clearance: | |
| | Complete security awareness | |
| | training within three months of | |
| | commencing in the Department and | |
| | at least once every five years | |
| | thereafter; | |
| | every year, read and acknowledge a | |
| | summary of your most important | |
| | security obligations; | |
| | make yourself familiar with the | |
| | Australian Government Protective | |
| | Security Manual, the Department's | |
| | Security Instructions and | |
| | departmental Administrative | |
| | Circulars on security issues; | |
| | advise Security Policy Section | |
| | (SPS) promptly of any changes in | |
| | your personal circumstances, for | |
| | instance if you, and if applicable | |
| | your partner, change name or | |
| | nationality; change your | |
| | relationship status, including | |
| | marriage or commencement of a | |
| | long-term relationship with a | |
| | partner of either sex, separation or | |
| | divorce; | |
| | Click NEXT to read the next page. | |
| 4a | Clearances must be re-evaluated after five | |
| | years. If you are still employed or engaged | |
| | by the Department at that time, you must | |
| | cooperate fully and promptly in the re- | |
| | evaluation process. If your clearance is not | |
| | successfully re-evaluated within six years | |
| | from the effect date of your clearance | |
| | advised above, it will lapse automatically. | |
| | Possession of a security clearance is a | |
| | condition of employment for all staff | |
| | regardless of full or part time status. Loss | |
| | of your clearance may be grounds for the | |
| | Department or the head contractor to | |
| | terminate your employment contract. | |
| | Yours sincerely | |
| | Agency Security Adviser | |
| | Click BACK to read the first page. Click | |
| | CONTINUE to return to your desk. | |

### Security Update

| Scene | | |
|---|---|---|
| ID | Content | Scene details |
| 5 | From: Agency/IT Security Adviser | Arrives on desk |
| | Title: Security Update | as an email flashing |
| | All staff are advised effective Monday 1^{st} | on the computer |
| | March 2008 the Agency will have in place a | screen. Can be |
| | new access control system for entry to the | saved for later or |
| | building. All staff will be contacted in the | deleted. |
| | next week with times for their new passes to | |
| | be issued. Any staff member on leave will | |
| | be allocated a time on their return. | |
| | Managers - please advise of staff | |
| | movements and authorised absences to | |
| | ensure all staff are accounted for. | |
| | Staff are also reminded of the NEED TO | |
| | KNOW PRINCIPLE. Remember - if you | |
| | don't know what level clearance other staff | |
| | have do not assume you can discuss your | |
| | projects with them. | |

### Menu

| Scene | | |
|---|---|---|
| ID | Content | Scene details |
| 6 | Things to do today . . . | Scene is your desk. |
| | Levels of security | Your to do list is displayed |
| | Unauthorised access of information | with a list of scenarios and |
| | Security of classified information | an indication of whether you |
| | New access control system | have completed that ‘task’ |
| | Procurement | or not. |
| | Use of Facebook | |
| | Scenario 7 | |
| | Scenario 8 | |
| | Scenario 9 | |
| | Scenario 10 | |
| | Scenario 11 | |
| | Scenario 12 | |
| | Scenario 13 | |
| | End of day procedures | |
| | Assessment | |
| | Select the scenario from the menu. | |
| | You may only select those options | |
| | accessible/available to you. | |

### Saved Files

| Scene ID | Content | Scene details |
|---|---|---|
| 7 | Saved files | Scene is your desk. |
| | Word document | A dialog box is displayed |
| | Security update | with saved files that the |
| | Etc | learner can access to |
| | Select the file you need to open. | review. |

Scenario 01: Levels of security

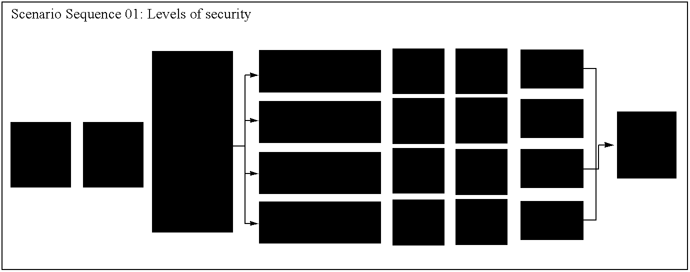

Scenario 01: Receive a phone call

| Scene ID | Content | Scene details |
|---|---|---|
| 1 | The phone is ringing. | Scene is your desk. |
| | Click the phone to answer it. | The phone on your desk |
| | | flashes - phone call - you |
| | | click on the phone icon and |
| | | the text opens across the |
| | | screen. |
| 1a | “Hi, it's Bob here. | |
| | I need to inform you that I have instigated an investigation concerning a | |
| | recent security breach within the Department.” | |
| | Bob goes on to explain the incident to you in sufficient detail to enable | |
| | you to carry out your role in the investigation. | |
| | He concludes his call with: “There will be a requirement for you to | |
| | prepare a brief for the investigating officer by Friday morning. Please | |
| | call by my office this afternoon and pick up the files with documentary | |
| | evidence that I want you to include with the brief.” | |
| | Click CONTINUE to go to Bob's office. | |
| 1b | {Transition screen} | You now head to the EA's |
| | | office to pick up the |
| | | documentation. |
| | | Note that we do not know if |
| | | the learners understand the |
| | | acronym, EA. Suggest that |
| | | we change this to Executive |
| | | Assistant's office. |

Scenario 01: Visit Bob's EA

| Scene ID | Content | Scene details |
|---|---|---|
| 2 | You are at Bob's office to pick up the file as arranged. However, when | Background is at the EAs |
| | you arrive, Sue, his EA, informs you that Bob had to unexpectedly | desk with the EA visible. |
| | leave on urgent business and won't be back till next week. | This information appears on |
| | What do you do? | the screen over the |
| | A. Ask Sue to find the file | background still visible |
| | B. Give Sue a quick overview | through it. |
| | C. Ask Sue if Bob has left you contact details | A list of questions appears |
| | D. Prepare brief without the files | under this writing - each |
| | Click each option for find out more then click SUBMIT to select your | question has the title then |
| | answer. | when you click on it the |
| | | wording under each |
| | | question appears |

Scenario 01: A. Ask Sue to find files

| Scene ID | Content | Scene details |
|---|---|---|
| 2a1 | You cannot afford to leave out the documentary evidence Bob feels is | The following additional |
| | vital information and must be presented with the brief. Bob was | text is displayed when you |
| | explicit with his instructions. Sue should know everything Bob is | click A. Ask Sue to find the |
| | working on and probably has access to his cabinets and computer. | files. |
| | Request she either finds the files in his office, or prints off a | |
| | hard copy for you. | |
| 2a2 | Consequence: | The background changes to |
| | I hear you are working on a security breach. Can you give me a | a coffee shop with people in |
| | head's up? What is going on? Which section is getting | line - the following appears |
| | grilled? Anything I should be worried about? | on the screen over the |
| | | screen with the background |
| | | visible through it . . . . |
| 2a3 | You are lined up to get a flat white coffee when you are | The following occurs if you |
| | approached by another colleague . . . | SUBMITTED answer A Ask |
| | | Sue to find files. |
| | | Background change to black |
| | | with the text I white. |
| 2a4 | Feedback: | The following text displays |
| | While this might help you get the information you need, it is not the | if you SUBMIT answer A |
| | right choice. In this case it is incorrect to assume Sue has the | Ask Sue to find flles. |
| | correct level of clearance or has even been informed about the existence | |
| | of the files. Informing Sue, however subtly, there are documents | |
| | relating to a confidential matter is incorrect. And secondly, directing | |
| | Sue to try to find confidential files or suggesting she look for either | |
| | hard copy or electronic files is not appropriate. By alerting Sue to | |
| | the existence of confidential files, you could have quite possibly | |
| | opened the door for confidential information to be leaked from your | |
| | department and rumours to begin. | |

Scenario 01: B. Give Sue a quick overview

| Scene ID | Content | Scene details |
|---|---|---|
| 2b1 | While you cannot afford to leave out vital information when presenting | The following additional |
| | the brief, you don't want to assume Sue knows about the file Bob was | text is displayed when you |
| | to leave you. Bob was explicit in his instructions for including the | click B. Give Sue a quick |
| | documentary evidence in your brief. Give Sue a quick summary of the | overview. |
| | urgency of the matter and why you need the files, and then ask her to | |
| | contact Bob immediately. Hopefully she can then tell you where to look | |
| | for the files. | |
| 2b2 | “I heard we might have a leak over in planning. I hear they've brought | Coffee shop scene. |
| | in an independent investigator.” | |
| | The other guy raises his shoulders in non-commitment and then | |
| | responds. | |
| | “You should never talk about projects or what you're working on if you | |
| | don't know the other person has the need to know the information. I | |
| | don't show anybody anything or talk about anything . . . . It's the best | |
| | policy. You never know who is allowed access unless you are directly | |
| | informed.” | |
| 2b3 | You are lined up to get a flat white coffee when you overhear the couple | The following occurs if you |
| | in front of you . . . | SUBMITTED answer B. |
| | | Give Sue a quick overview. |
| | | Background change to black |
| | | with the following - You are |
| | | lined up to get a flat white |
| | | coffee when you overhear |
| | | the couple in front of you. |
| 2b4 | Feedback: | The following text displays |
| | While this might help you get the information you need, it is not the | if you SUBMIT answer B. |
| | right choice. In this case it is incorrect to assume Sue has the correct | Give Sue a quick overview. |
| | level of clearance or has even been informed about the existence of the | |
| | files, or in fact even knows about the investigation. Informing Sue, | |
| | however subtly, there are documents relating to a confidential matter | |
| | is incorrect. And secondly, directing Sue to ring Bob about confidential | |
| | files is also inappropriate. By alerting Sue to the existence of | |
| | confidential files, you could have quite possibly opened the opportunity | |
| | for confidential information to be leaked from your department. | |
| | Rumours could stem from this activity. | |

Scenario 01: C. Ask Sue if Bob has left you contact details

| Scene ID | Content | Scene details |
|---|---|---|
| 2c1 | Check with Sue whether Bob has left you a mobile phone number or | The following additional |
| | other numbers where he can be reached. If not, ask her how you could | text is displayed when you |
| | contact him on a relatively urgent matter. If Bob has left any files or | click C. Ask Sue if Bob has |
| | envelopes with Sue, this might trigger her memory. If this fails, do | left you contact details. |
| | nothing. When you meet for the briefing, you can mention Bob has files | |
| | with documentary evidence relating to the brief you were unable to | |
| | obtain due to Bob's sudden departure. | |
| 2c2 | You are back at your desk. The phone is ringing . . . | The following occurs if you |
| | | SUBMITTED answer B. |
| | | Give Sue a quick overview. |
| | | Background change to black |
| | | with the following - You are |
| | | back at your desk. The |
| | | phone is ringing . . . |
| 2c3 | Click the phone to answer it. | The phone rings |
| 2c4 | Hi, Bob here. | Answer the phone and the |
| | I just wanted to give you a quick call to apologise for not leaving the | following appears across |
| | security envelope with the files relating to the security investigation | the screen. |
| | with Sue instead of in my cabinet. You showed excellent judgement by | |
| | contacting me on the mobile and getting the files yourself. Sue was not | |
| | privy to the investigation. I'm glad you were able to present all the | |
| | pertinent information. | |
| | My wife's car accident sure took my mind off work . . . thank goodness | |
| | she is not hurt. I'll catch up with you next week and we can debrief | |
| | the incident. | |
| 2c5 | Feedback: | The following text displays |
| | This is the best response. As you don't know what level of clearance | if you SUBMIT answer C. |
| | Sue has, you cannot assume she either knows about the investigation or | Ask Sue if Bob has left you |
| | has knowledge about Bob's files relating to the incident. All | contact details. |
| | classified information must be treated with the utmost diligence. You | |
| | have not only adhered to the correct procedure, but you have ensured | |
| | unauthorised leaks will not occur. Finally, you are obliged to be honest | |
| | and upfront in your role in the investigation. If you had resisted | |
| | telling him of the existence of the files, it may have hindered the | |
| | investigation. | |

Scenario 01: D. Prepare brief without files

| Scene ID | Content | Scene details |
|---|---|---|
| 2d1 | As Bob has overlooked leaving you the files and you don't feel you can | The following additional |
| | mention them directly with Sue, it is best to simply leave them out when | text is displayed when you |
| | preparing your brief If they were vitally important, Bob would have | click D. Prepare brief |
| | made sure you would have had them. Go ahead with the briefing and | without files. |
| | only present your material. As you don't have Bob's files, you | |
| | should not mention them. If the investigator wants more, he can talk | |
| | to Bob when he gets back. | |
| 2d2 | You are back at your desk. The phone is ringing. | The following occurs if you |
| | | SUBMITTED answer D. |
| | | Prepare brief without files. |
| | | Background change to black |
| | | with the following - You are |
| | | back at your desk. The |
| | | phone is ringing . . . |
| 2d3 | Click the phone to answer it. | The phone rings |
| 2d4 | I just wanted to give you a call to apologise for not leaving the security | Answer the phone and the |
| | envelope with the files relating to the security investigation with Sue | following appears across |
| | instead of in my cabinet. Sue was not privy to the investigation. How- | the screen. |
| | ever I'm upset that you elected to not mention the presence of other | |
| | files during the briefing, We now have a problem, as it can be construed | |
| | that we purposely hid information. This is against procedure. While my | |
| | wife's car accident sure took my mind off work - and thank goodness | |
| | she is not hurt, we will need to discuss this whole incident next week | |
| | and decide how we can proceed. | |
| 2d5 | Feedback: | The following text displays |
| | | if you SUBMIT answer D. |
| | You have half of the answer correct. It was correct to not mention the | |
| | files to Sue; however, you should not have elected to hide the fact | |
| | other files existed. By omitting the fact you have knowledge about addi- | |
| | tional information relating to the investigation, you are negligent. | |
| | You are obliged to share the information that other documents exist. | |

Scenario 01: General conclusion
Screen ID: 3

| Scene ID | Content | Scene details |
|---|---|---|
| 3 | General Issue in relation to the first scenario: | The following information is |
| | It is important to recognise different levels of security clearances are in | to be mandatory for each |
| | place for staff. It is also important to understand people in your depart- | question/answer - must |
| | ment will have totally different security clearance levels. There are two | read before they go on to |
| | types of security clearance; those classified as National Security | the next scenario - |
| | Clearances i.e. CONFIDENTIAL, SECRET and TOP SECRET, and | regardless if they got it right |
| | Non-National Clearances i.e. Protected and Highly Protected. | or wrong. This information |
| | Furthermore, regardless of a person's designated security level, not all | is the security background |
| | information that is available at any given time on matters is automa- | to why we did that |
| | tically released. It is done on what is called, “a need to know basis.” | particular scenario. |
| | Classified files must only be given to those people who have the appro- | |
| | priate security clearance. You should never assume that a person such as | |
| | an assistant or an EA, even though they work for a person who has the | |
| | correct security clearance, has the same. If you are not sure whether | |
| | another person does have security clearance to sight or even know of the | |
| | existence of files or information, you must not mention documents exist | |
| | either directly or though suggestion. | |

Scenario 02: Unauthorised access of information

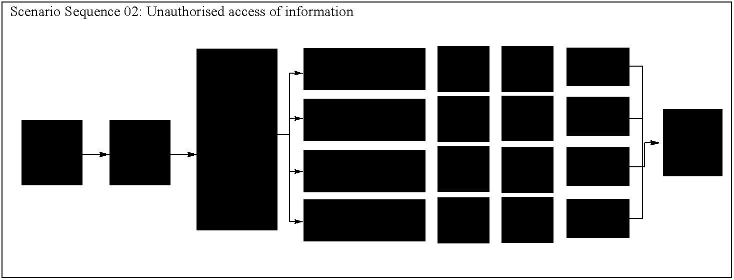

Scenario 02: Mary requests stress leave

| Scene ID | Content | Scene details |
|---|---|---|
| 1 | Mary comes to your office and asks for a week of leave. She explains she is | Background is your office |
| | having personal difficulties as her daughter has moved back home with her | with the writing over the |
| | children following a violent end to her relationship. Mary is certainly agitated, | scene |
| | upset and distressed about her daughter's plight. It appears her daughter may | |
| | need to seek protection, or at the very least is very vulnerable. | |
| | You immediately grant her leave and know she will return as soon as possible | |
| | as Mary has always been one of your hardest working team members. You let | |
| | her know you will support her in any way possible. | |
| 1a | | Time passes, you have to |
| | | attend a meeting and go to |
| | | the meeting room. |

Scenario 02: Meeting room conversations

| Scene ID | Content | Scene details |
|---|---|---|
| 2 | While at a meeting, you overhear two of your staff talking about how easy it is | Scene is the meeting room |
| | to access the internal data bases to get all sorts of information on people. | with a number of people |
| | By listening to their comments, you come to suspect they might be actually | milling around |
| | talking about Mary. As you leave the room, you can't help but think Mary | |
| | might be gathering information about her daughter's ex-boyfriend. Could this | |
| | be rumor or truth? | |
| | What should you do? | |
| | A. Don't act on gossip | |
| | B. Refer the matter to the Agency Security Advisor for further action | |
| | C. Review the information policy with the whole team | |
| | D. Speak with Mary directly | |
| | Click each option for find out more then click SUBMIT to select your answer. | |

Scenario 02: A. Don't act on gossip

| Scene ID | Content | Scene details |
|---|---|---|
| 2a1 | Mary is one of your best workers. This is idle gossip. It is not appropriate to do | Text placed over current |
| | anything at this point. Resolve to keep a close eye on Mary however. If you | scene. |
| | started investigating every time you overheard staff talk, it would kill | |
| | productivity and certainly negatively impact staff morale. | |
| 2a2 | You are back at your desk . . . | Scene: transition. |
| | | The following occurs if you |
| | | SUBMITTED answer A. |
| | | Don't act on gossip. |
| | | Background change to black |
| | | with the following - You are |
| | | back at your desk. |
| 2a3 | Consequence | Scene: The front page of the |
| | Government Staff once again caught accessing internal database information for | Daily Advertiser appears |
| | personal gain. A public servant has been charged with accessing a government | spinning onto your desk . . . , |
| | database to gain access to her daughter's ex-partner information. She will | |
| | attend court next week following the charges. | |
| 2a4 | Feedback: | |
| | This was unwise to dismiss what could be just gossip. If Mary is actually | |
| | accessing internal database information, she is committing a serious security | |
| | breach. | |

Scenario 02: B. Refer the matter to the Agency Security Adviser for further action

| Scene ID | Content | Scene details |
|---|---|---|
| 2b1 | Accusation or truth, this could be serious. Mary's action, if proven, could | The following additional |
| | constitute a serious security breach. You have no choice but to refer the matter | text is displayed when you |
| | to the Security Section. | click B. Refer the matter to |
| | | the Agency Security Adviser |
| | | for further action. |
| 2b2 | You are back at your desk . . . | Scene: transition. |
| | | Background change to black |
| | | with the following - You are |
| | | back at your desk. |
| 2b3 | Feedback: | |
| | This is the best answer. Even though it may prove to be only idle gossip, once | |
| | it has come to your attention, you have a duty to refer the matter under | |
| | the PSM (Privacy and Security Manual) guidelines. | |

Scenario 02: C. Renew the information policy with the whole team

| Scene ID | Content | Scene details |
|---|---|---|
| 2c1 | You don't want to accuse Mary or inadvertently jump to any conclusions | The following additional |
| | about her behaviour. It is best to call a team meeting and review the policy | text is displayed when you |
| | for everyone. If Mary has acted inappropriately, she will probably come | click C. Review the |
| | forward and speak to you independently. Even if she doesn't come forward, | information policy with your |
| | she will certainly get the message and stop accessing the data bases. | team. |
| 2c2 | You are back at your desk . . . | Background change to black |
| | | with the following - You are |
| | | back at your desk. |
| 2c3 | Consequence | The front page of the Daily |
| | Government Department's once again cover up staff accessing internal | Advertiser appears spinning |
| | database information for personal gain. A senior public servant has been | onto your desk . . . , |
| | accused of covering-up for a staff member who it has been alleged accessed a | |
| | government database to gain access to an individual's personal information. | |
| | The public servant is facing charges under the Crives Act and will be answering | |
| | a Code of Conduct enquiry. | |
| 2c4 | Feedback: | |
| | While it might have seemed the “nice” thing to do, and you avoided embar- | |
| | rassing Mary, this is not considered the appropriate step. If Mary is actually | |
| | accessing internal database information incorrectly, she is committing a seious | |
| | security breach. | |

Scenario 02: D. Speak with Mary directly

| Scene ID | Content | Scene details |
|---|---|---|
| 2d1 | It is best to talk to Mary in private. You don't want to embarrass her in | The following additional |
| | front of others. Try to find out if Mary had been seeking information for | text is displayed when you |
| | personal reasons. Make this a friendly, non-threatening meeting. If Mary admits | click D. Speak with Mary |
| | to inappropriate behaviour, issue her a warning. If she doesn't admit to using | directly. |
| | the system, remind her of the rules. | |
| 2d2 | Back at your desk . . . | Scene: transition. Back at |
| | | your desk on black |
| | | background. |
| 2d3 | Mary comes to your office crying. It seems there was truth to the accusation | the scene of your desk |
| | she was trying to find incriminating background on her daughter's ex- | |
| | boyfriend. She sincerely apoligises and adds she really couldn't find anything | |
| | but admits to looking into data base information. | |
| | You now have to deal with this security breach and inform Mary you will | |
| | have to discuss the situation in full and decide what action to take. | |
| 2d4 | Feedback: | |
| | While it might appear you are being sensitive, and you have shown concern | |
| | about embarrassing Mary, this is not considered the appropriate step. If Mary | |
| | is actually accessing internal database information, she is committing a serious | |
| | security breach. It is highly unlikely Mary will openly admit to wrong doing, | |
| | and if she does, and gets off with only a slap on the wrist, you are sending a | |
| | poor message to the rest of your team. They might interpret your actions as | |
| | being very relaxed concerning breaches. | |

Scenario 02: General conclusion

| Scene ID | Content | Scene details |
|---|---|---|
| 3 | General Issue: | The following information is |
| | It is a serious security breach for any employee to access government data | to be mandatory for each |
| | base information and use it for any reason other than official business. It is | question/answer - must read |
| | also necessary to immediately investigate this even if there is only a | before they go on to the next |
| | a suspicion of inappropriate access. | scenario - regardless if they |
| | | got it right or wrong. This |
| | | information is the security |
| | | background to why we did |
| | | that particular scenario |

Scenario 03: Security of classified information

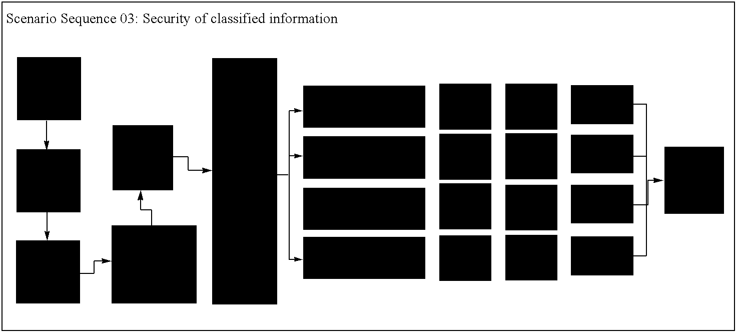

Scenario 03: Memo: Security responsibilities when travelling

| Scene ID | Content | Scene details |
|---|---|---|
| 1a | All Staff Intranet Alert | Memo lands on your desk - |
| | From: Agency/IT Security Adviser | flashing so you have to |
| | All staff are to be aware of their responsibilities in relation to the security | answer it. The memo can be |
| | of classified information. Please ensure you utilise the correct transport and | saved or deleted into your |
| | transmission procedures when handling classified and sensitive information. | own notice board which is |
| | When travelling intra or interstate you are to secure any classified information | an icon on your desk. |
| | in a SCEC (Security Construction and Equipment Committee) endorsed brief- | |
| | case which can be signed out from the Security Section for the duration of your | |
| | travel. | |
| | If you are required to travel overseas please discuss your requirements with the | |
| | relevant Branch Head in conjunction with the Agency Security Adviser. | |
| 1b | All Staff Intranet Alert | |
| | From: Agency/IT Security Adviser | |
| | All staff are to be vigilant in the movement of portable and attractive items. All | |
| | items are to be signed out though Central Registry and are to be kept secure at | |
| | all times. If you need any assistance please discuss with your Manager or the | |
| | ASA. | |
| 1c | | Scene: Passage of time. You |
| | | are transported to a con- |
| | | versation at the airport . . . |
| 1d | Person A says: What is the reason behind the changes to travel arrangements? | The following is a crowd |
| | Aren't there enough policies already in place? | scene at an airport lounge |
| | Person B says: I hope the department will pay for the excess baggage cost if I | (Qantas) with the information |
| | have to travel with an extra case? | written on the screen. |
| | Person C says: I thought staff would know about this requirement? this is | |
| | no different to what should have been happening all along. | |
| 1e | | Passage of time. Screen to |
| | | indicate passage of time. |
| | | You are at home . . . |

Scenario 03: Thief steals Fred's laptop bag

| Scene ID | Content | Scene details |
|---|---|---|
| 2 | You just arrived home when you receive a phone call from Fred. Fred is one | Home scene - lounge room - |
| | of your team. He had travelled to Hobart yesterday to meet with a Hobart | information displays across |
| | State manager to discuss some issues which required his carrying several | the scene |
| | sensitive files from your office. As Fred had not needed his laptop he informs | |
| | you he disregarded the Intranet Alert and elected to carry the files in his | |
| | laptop case. He explained he did this as he had no requirement for the laptop | |
| | and found it a lot lighter and easier to carry. He also had his mobile phone | |
| | in the case at the time it was stolen. Fred certainly appears distressed. | |
| | You know a number of staff has done this in the past, yourself included. | |
| | He is still in Hobart, and he asks you what you want him to do. | |
| | What do you do? | |
| | A. Check Fed is OK and have him contact the police | |
| | B. Check Fred is OK and refer the matter to the ASA | |
| | C. Begin an investigation | |
| | D. Issue Fred with a formal warning | |
| | Click each option to find out more then click SUBMIT to select your answer. | |

Scenario 03: A. Check Fred is OK and have him contact the police

| Scene ID | Content | Scene details |
|---|---|---|
| 2a1 | You have a duty of care with your workers. Ensure he is not harmed - your first | This information pops up |
| | priority should be his safety and wellbeing. Confirm the laptop is not | over the lounge room scene. |
| | stolen and inventory the missing files. As Fred is in Hobart, ask him | |
| | to contact the local police who can act on the theft. | |
| 2a2 | The Daily News - Security leak! | Scene: You pick up a paper |
| | You pick up the morning paper and see a headline that junps out to you. It | and read in your lounge |
| | seems a journalist has come across information relating to Fred's Hobart | room . . . |
| | meeting. This is your worst fear . . . now you will need to go up higher to | |
| | deal with the matter. | |
| | You wish you could wind the clock back and make sure Fred had taken the | |
| | right briefcase even if it is big, awkward and heavy. At least he mightn't | |
| | have left it lying around for someone to pick up so easily! | |
| 2a3 | Feedback: | |
| | While it is important the ensure Fred is unharmed, you have overlooked the | |
| | most important issue in this scenario. Fred should not have been transporting | |
| | departmental documents in an unauthorised storage container. If these docu- | |
| | ments fall into the wrong hands there could be serious repercussions. | |

Scenario 03: B. Check Fred is OK and refer the matter to the ASA

| Scene ID | Content | Scene details |
|---|---|---|
| 2b1 | This is a serious matter but it is not within your area of responsibility to deal | This information pops up |
| | with it. You need to immediately refer the matter to the ASA. Tell Fred to | over the lounge room scene. |
| | continue with his trip as he still has work to do and plan to follow up and | |
| | discuss his conduct when he returns. | |
| 2b2 | You are at the office canteen. | Passage of time. Screen to |
| | | indicate passage of time and |
| | | change of scene. |
| 2b3 | The ASA get back to you with great news. It seems they followed up | Scene is a business canteen |
| | with an immediate investigation which included contacting the security | |
| | guards at the Hobart Harbourside Hotel where Fred stayed. The laptop | |
| | case was found abandoned in the back alley with all the files still in side. | |
| 2b4 | Feedback: | |
| | You have understood the seriousness of this situation as stolen / lost classified | |
| | documents can tarnish the department's reputation and potentially the nation's | |
| | security. The ASA is the correct person to notify. It is their role to deal with | |
| | the situation from this point. You also need to speak to Fred about his poor | |
| | judgement in regard to his security responsibilities on his return. | |

Scenario 03: Begin an investigation

| Scene ID | Content | Scene details |
|---|---|---|
| 2c1 | You understand the seriousness of this breach and ensure you leave no | This information pops up |
| | stone unturned. The department's reputation as well as the nation's reputation | over the lounge room scene. |
| | is on the line. You begin an immediate and thorough investigation. | |
| 2c2 | You are back at your desk. | Passage of time. Screen to |
| | | indicate passage of time and |
| | | change of scene. |
| 2c3 | The ASA contacts you to ask why you have instigated a security investigation | Scene is your office desk. |
| | as it is not your responsibility. They explain the PSM clearly states all | |
| | security investigations are to be referred to the appropriate person, i.e. | |
| | the ASA. | |
| 2c4 | Feedback: | |
| | You are right in this is a serious security breach and does need to be | |
| | investigated; however, this is beyond your responsibility. You must advise | |
| | the ASA immediately so they can take appropriate action. You do not know | |
| | how the thief will use these documents and if the situation is revealed to the | |
| | public, it can seriously tarnish the department's and the nation's reputation. | |

Scenario 03: D. Issue Fred with a formal warning

| Scene ID | Content | Scene details |
|---|---|---|
| 2d1 | There is no sense in launching into a full scale investigation at this point. The | This information pops up |
| | laptop case could be anywhere! Should anything fall into the wrong hands, | over the lounge room scene. |
| | you will need to deal with that when the time comes. However, Fred was | |
| | negligent and action needs to be taken. Issue him with a formal warning. As | |
| | Fred has an untarnished security record to date, this will act as a deterrent | |
| | to not only him but to others who will need to be notified. | |
| 2d2 | You are walking about the office and notice a news paper . . . | Passage of time. Screen to |
| | | indicate passage of time and |
| | | change of scene to your |
| | | office area. |
| 2d3 | You pick up the morning paper and see a headline that jumps out to you. It | Scene is the office |
| | seems a journalist has come across information relating to Fred's Hobart | environment. |
| | meeting. This is your worst fear . . . now you will need to go up higher to | Daily news - Security leak! |
| | deal with the matter. | |
| | You wish you could wind the clock back and make sure Fred had taken the | |
| | right briefcase even if it is big, awkward and heavy. At least he mightn't | |
| | have left it lying around for someone to pick up so easily! | |
| 2d4 | Feedback: | |
| | You are right this is a serious security breach, however, it is not enough to | |
| | just give Fred a warning, and he should not have been transporting depart- | |
| | mental documents in an unauthorised storage container. This is a serious | |
| | security breach and your ASA needs to be advised immediately so they can | |
| | take appropriate action. You do not know how the thief will use these | |
| | documents and if the situation is revealed to the public, it can seriously | |
| | tarnish the department's and the nation's reputation. | |

Scenario 03: General conclusion

| Scene ID | Content | Scene details |
|---|---|---|
| 3 | General Issue: | The following information is |
| | The transportation of department confidential files must be made using the | to be mandatory for each |
| | approved secure briefcase. This rule is for any travel either intra or interstate. | question/answer - must read |
| | When travelling you are to secure any classified information in a SCEC | before they go on to the |
| | (Security) Construction and Equipment Committee) endorsed briefcase | next scenario - regardless is |
| | which can be signed out from the Security Section for the duration of your | they got it right or wrong. |
| | travel. If you are required to travel overseas please discuss your require- | This information is the |
| | ments with the relevant Branch Head in conjunction with the Agency Security | security background to why |
| | Adviser. | we did that particular |
| | Use of unauthorised storage containers to carry classified files is considered a | scenario. |
| | serious security breach. Should files be stolen it is your duty to contact the | |
| | ASA immediately so they can take the appropriate action. | |

Scenario 04: New access control system

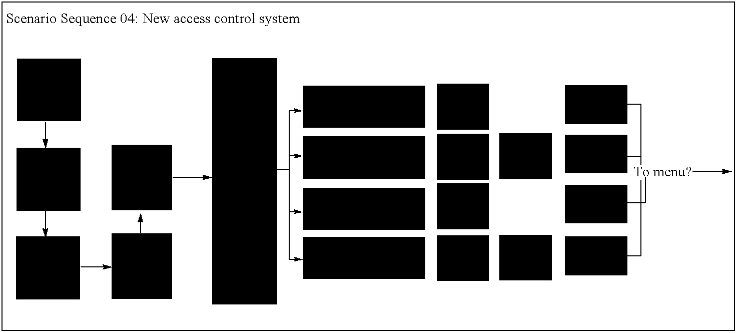

Scenario 04: New access control system messages

| Scene ID | Content | Scene details |
|---|---|---|
| 1a | All Staff Intranet Alert | Onto desk we receive a |
| | From: Agency/IT Security Adviser | memo - must open and can |
| | Staff are reminded to ensure no unauthorised entry to the building | either save or delete. |
| | facilitated. | The following then occurs |
| | As advised in the all staff meeting of the 14^{th}, serious physical threats have | (information required to |
| | been made against a number of staff members in the past few weeks. Police | answer question): |
| | have advised they will be patrolling the building on a regular basis over | |
| | the coming weeks as a deterrent to any unauthorised access. Security | |
| | guards will be in place as per normal. | |
| | Any staff who have concerns about access to the building should speak to | |
| | their managers in the first instance. | |
| 1b | I will be on leave until the 2^{nd} week of the month. How do I access the building | Email from Manager |
| | on my first day back? | appears as an email on your |
| | | screen - then opens out for |
| | | you to read: |
| 1c, 1d | It's about time we got an access system on the front entry. There have been too | Phone call from one of your |
| | many incidents lately. | staff - phone ringing with |
| | | you having to answer - |
| | | which then opens out onto |
| | | screen for you to read |
| 1e | Your section is due for their new id photo's Friday between 1100-1200 and | General email from ASA |
| | Monday 0930-1030. | appears as an email on your |
| | | screen - then opens out for |
| | | you to read |
| | | Passage of time, transition |
| | | to the barriers. |

Scenario 04: Jumping the barrier

| Scene ID | Content | Scene details |
|---|---|---|
| 2 | You are just returning to the office after your lunch break. After you swipe | Scene is the barriers into |
| | your security access card and go through the barrier, you notice someone | the Department |
| | you don't recognise slip through the barrier after you. Before you can say | |
| | anything, he mutters an apology “sorry, I forgot my card and I'm running | |
| | late for a meeting”. He quickly walks towards the elevators and disappears. | |
| | What should you do? | |
| | A. Do nothing - it's a new system problem | |
| | B. Challenge him | |
| | C. This is not your job | |
| | D. Challenge him | |
| | Click each option to find out more then click SUBMIT to select your answer. | |

Scenario 04: Do nothing, it's a new system problem

| Scene ID | Content | Scene details |
|---|---|---|
| 2a1 | The security system has only recently been installed. People are still getting use | Information pops over |
| | to it, and besides you think this guy did have his pass on him, he just didn't | current scene. |
| | swipe it. Mention something to him if you catch him before he goes up in the | |
| | elevator, otherwise it's really not your problem. | |
| 2a2 | Daily Examiner - Woman assaulted at work by violent ex-husband | Newspaper article spinning |
| | A woman was beaten unconscious by her ex-husband after he gained access to | onto the screen showing |
| | her workplace. The man managed to gain access to the secure building and | front page of the Daily |
| | confront his wife in her work area where he beat her before her colleagues | Examiner |
| | could intervene. Police attended and the man was arrested and will face | |
| | court tomorrow. | |
| 2a3 | Feedback: | |
| | This is not the appropriate response. This is a security breach. Even though he | |
| | may have had his security pass with him, the policy clearly states everyone | |
| | entering and exiting the building must swipe their pass or be issued with a | |
| | visitors pass. | |

Scenario 04: B. Challenge him

| Scene ID | Content | Scene details |
|---|---|---|
| 2b1 | The policy clearly says no-one can enter your building without going through | Scene is at the security |
| | the access control point correctly. Catch up with him and ask to see his ID | gates - this information to |
| | pass, and should he not have it, direct him to the Security area and escort | display over the gates |
| | him at this time. | |
| 2b2 | Back at your desk . . . | Passage of time, you are at |
| | | your desk. |
| 2b3 | Consequence - Thank you from the woman. The ASA visits your desk and | Scene is your desk. |
| | thanks you on behalf of a staff member. The individual you stopped was | |
| | not in fact an employee but someone who was trying to access the | |
| | department to harass an employee. | |
| 2b4 | Feedback: | |
| | This is an appropriate response, but may carry a risk. You were right in appre- | |
| | ciating the person has entered the building incorrectly and has therefore | |
| | caused a security breach. If you do not feel safe in challenging someone you do | |
| | not know, the best thing to do is to alert the security guards or your Security | |
| | staff if you do not have on-site guards. | |

Scenario 04: C. This is not your job

| Scene ID | Content | Scene details |
|---|---|---|
| 2c1 | You are not trained as a security guard, and besides, this is not your job. This is | Information pops over |
| | why there are security officers on the job. They will stop him and insist he | current scene. |
| | follows protocol if they think it is necessary, and besides all that he | |
| | might be dangerous. | |
| 2c2 | Daily Examiner - Woman assaulted at work by violent ex-husband | Newspaper article spinning |
| | A woman was beaten unconscious by her ex-husband after he gained access to | onto the screen showing |
| | her workplace. The man managed to gain access to the secure building and | front page of the Daily |
| | confront his wife in her work area where he beat her before her colleagues | Examiner |
| | could intervene. Police attended and the man was arrested and will face | |
| | court tomorrow. | |
| 2c3 | Feedback: | |
| | While you have been right in giving thought to the fact he might be dangerous, | |
| | you were incorrect in not doing something about this situation. The unlawful | |
| | entry of a person into a secure building constitutes a security breach. | |

Scenario 04: D. Notify the security guard

| Scene ID | Content | Scene details |
|---|---|---|
| 2d1 | You don't feel comfortable going up to a stranger, but you know he should not | Scene is at the security |
| | get into the building without using his security pass. Alert the security staff and | gates - this information to |
| | let them deal with the situation. | display over the gates |
| 2d2 | Back at your desk . . . | Passage of time, you are at |
| | | your desk |
| 2d3 | Consequence - Thank you from the woman. The ASA visits your desk and | Scene is your desk |
| | thanks you on behalf of a staff member. The individual you stopped was not | |
| | in fact an employee but someone who was trying to access the department | |
| | to harass an employee. | |
| 2d4 | Feedback: | |
| | This is an appropriate response. If you do not feel secure in challenging the | |
| | person it is best to alert the security staff | |

Scenario 05: Procurement

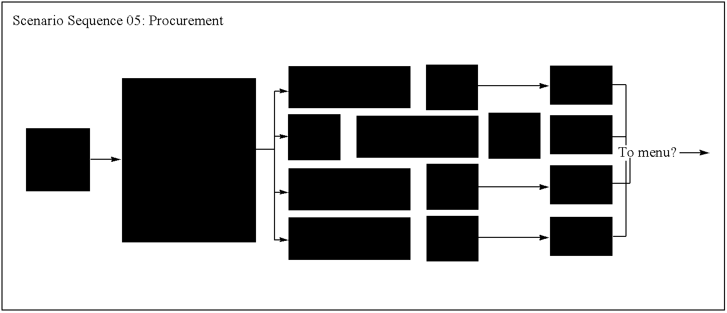

Scenario 05: Procurement guidelines

| Scene ID | Content | Scene details |
|---|---|---|
| 1 | Re: Procurement guidelines | General email from ASA |
| | All staff dealing with tender documents or contract negotiations are reminded | appears as an email on your |
| | they are to be fully conversant with the Procurement Guidelines in Part G | screen - then opens out for |
| | of the PSM. While the tendering party has a need to disclose any conflict | you to read |
| | of interest, any staff member who may have a conflict of interest through | |
| | friendship or previous contact should notify their Project Manager immediately. | |
| | If you have any questions please refer them to your manager or directly to the | |
| | Security Section. | |

Scenario 05: Leak of information

| Scene ID | Content | Scene details |
|---|---|---|
| 2 | While sitting at your desk you overhear a good friend and work colleague on | Scene: sitting at desk |
| | the phone discussing with another friend, who doesn't work for the government | |
| | the fact the company they work for did not get a contract with the department. | |
| | “I thought I would give you a heads up that you didn't win the CCTV | |
| | contract. It hasn't been announced yet, so don't say anything” | |
| | What do you do? | |
| | A. Do nothing | |
| | B. Have a quiet word | |
| | C. Commence an investigation | |
| | D. Refer the matter to the ASA | |
| | Click each option for find out more then click SUBMIT to select your answer. | |

Scenario 05: A. Do nothing

| Scene ID | Content | Scene details |
|---|---|---|
| 2a1 | They are both friends and while you know he should not have said anything | Scene: still at your desk |
| | you know his friend will not say anything. | More information is |
| | | displayed over the scene. |
| 2a2 | Consequence | Scene: Invitation envelope |
| | You are requested to attend an interview in relation to a serious breach of | appears on screen and |
| | security where your conduct is being questioned in relation to tender | opens up to show the |
| | information being passed on without approval. | following text |
| 2a3 | Feedback: | |
| | This is not the right decisiorn You know it is wrong and your colleague should | |
| | not have said anything, this could have far reaching consequences for the | |
| | department as it breaches the Code of Conduct, Procurement and Information | |
| | Security Guidelines under the PSM guidelines. | |

Scenario 05: B. Have a quiet word

| Scene ID | Content | Scene details |
|---|---|---|
| 2b1 | You go to your friend's desk. | Passing of time and location |
| | | to office discussion scene, |
| 2b2 | You know this is wrong but you can't just let it go. If you say something to | Scene: at your friend's desk. |
| | someone you are compounding the problem so you just have a quiet word with | |
| | your friend and give him a warning reminding him of his responsibilities | |
| | regarding information for procurement and passing on official information. | |
| 2b3 | Consequence | Scene: Invitation envelope |
| | You are requested to attend an interview in relation to a serious breach of | appears on screen and |
| | security where your conduct is being questioned in relation to tender | opens up to show the |
| | information being passed on without approval. | following text |
| 2b4 | Feedback: | |
| | This is not the right decision. While it is sometimes difficult to see friends do | |
| | the wrong thing, you have a responsibility to your employer. This is a serious | |
| | breach of security that could have far reaching consequences. | |

Scenario 05: C. Commence an investigation

| Scene ID | Content | Scene details |
|---|---|---|
| 2c1 | You know your friend has done the wrong thing and you immediately start an | Scene: your office on the |
| | investigation into how he found out the information and who else he may | phone |
| | have told. | Additional text displayed |
| | over scene. | |
| 2c2 | Consequence | Scene: in your office |
| | The ASA contacts you to ask why you have instigated a security investigation | |
| | as it is not your responsibility. They explain the PSM clearly states all security | |
| | investigations are to be referred to the appropriate person, i.e. the ASA. | |
| | Scenario 05: D. Refer the matter to the ASA | |
| 2c3 | Feedback: | |
| | You are right in this is a serious security breach and does need to be investi- | |
| | gated; however, this is beyond your responsibility. You must advise the ASA | |
| | immediately so they can take appropriate action. While it is your responsibility | |
| | to notify the ASA of any security breaches it is not within your role or | |
| | responsibilities to investigate the breach. | |

Scenario 05: D. Refer the matter to the ASA

| Scene ID | Content | Scene details |
|---|---|---|
| 2d1 | This is a serious matter but it is not within your area of responsibility to deal | Scene: your office on the |
| | with it. You need to immediately refer the matter to the ASA. | phone |
| | | Additional text displayed |
| | | over scene. |
| 2d2 | Consequence | Scene: in your office |
| | The ASA gets back to you to let you know the Project Manager was able to talk | |
| | to all the tendering parties and provide them with the appropriate feedback. | |
| 2d3 | Feedback: | |
| | You have understood the seriousness of this situation as this type of infor- | |
| | mation breach could have serious repercussions for the department's | |
| | reputation. | |
| | The ASA is the correct person to notify; it is their role to deal with the | |
| | situation from this point. You know the ASA will also speak to the Project | |
| | Manager to discuss the best course of action. | |

Scenario 06: Use of Facebook

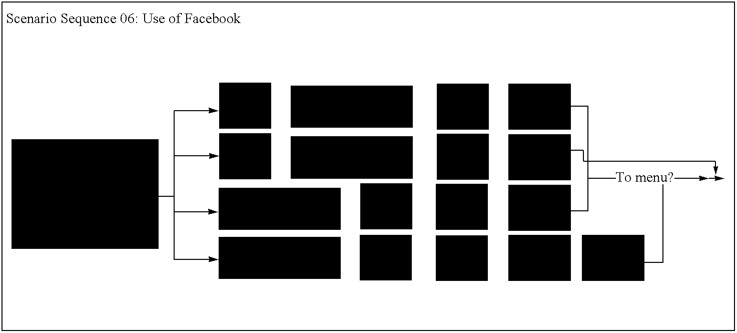

Scenario 06: Use of facebook

| Scene ID | Content | Scene details |
|---|---|---|
| 2 | You logon on to your Facebook account and find a message posted from a | Scene: you are sitting at |
| | friend saying they have missed out on a government contract in | home in the lounge room / |
| | relation to installing CCTV equipment. | study |
| | What action do you take? | |
| | A. Post your own message on Facebook in agreement | |
| | B. Post your own message on Facebook refuting the information | |
| | C. Do nothing | |
| | D. Discuss with your manager | |
| | Click each option to find out more then click SUBMIT to select your answer. | |

Scenario 06: A. Post your own message on Facebook in agreement

| Scene ID | Content | Scene details |
|---|---|---|
| 2a1 | Scene | Transition screen from |
| | | lounge to laptop screen. |
| 2a2 | You know this is your department so you respond. You post to your friends | Scene: computer screen |
| | Facebook that your department is idiotic for not choosing his company. You | with blank white page in |
| | add that you believe the company they chose is good friends of the chair | box |
| | of the panel. | |
| 2a3 | Consequence | Scene: different office with |
| | A senior manager in the workplace comes across your page on Facebook and | a computer screen up with |
| | immediately reports you to the ASA for the post you made about the contract | writing on the screen - |
| | and your department. The ASA begins an investigation as you have released | doesn't matter what it is, |
| | official information. | make it small so it is not |
| | While some people on Facebook close their viewing to friends only, others | readable. |
| | have it open to all. A breach occurs regardless if the site is closed or open. | |
| 2a4 | Feedback: | |
| | This is not the right thing to do. It is important when on Facebook and on | |
| | other social networking sites that you are very particular not to discuss | |
| | work, work related issues or mention the department by name. | |

Scenario 06: B. Post your own message on Facebook refuting the information

| Scene ID | Content | Scene details |
|---|---|---|
| 2b1 | | Transition screen from |
| | | lounge to laptop screen. |
| 2b2 | You know this is your department so you respond. You post to your friends | |
| | Facebook that your department has the right to choose the best company for | |
| | the job. You add that you believe the decision has not been made official | |
| | and at this stage it is just rumour anyway. | |
| 2b3 | Investigation: | Scene: different office with |
| | A senior manager in the workplace comes across your page on Facebook and | a computer screen up with |
| | immediately reports you to the ASA for the post you made about the contract | writing on the screen - |
| | and your department. The ASA begins an investigation as you have released | doesn't matter what it is, |
| | official information. | make it small so it is not |
| | While some people on Facebook close their viewing to friends only, others | readable. |
| | have it open to all. A breach occurs regardless if the site is closed | |
| | or open. | |
| 2b4 | Feedback: | |
| | This is not the right thing to do. It is important when on Facebook and | |
| | on other social networking sites that you are very particular not to discuss | |
| | work, work related issues or mention the department by name. | |

Scenario 06: C. Do nothing

| Scene ID | Content | Scene details |
|---|---|---|
| 2c1 | You decide it is not up to you to comment on this matter. You resolve to speak | Scene: you are sitting at |
| | to the ASA about the use of Face Book and what information staff may be | home in the lounge room / |
| | posting on it. You also decide to speak to your own staff and other | study |
| | colleagues to alert them to the risks of posting information on the net | |
| | on any of these types of social networking sites. | |
| 2c2 | Back at your desk . . . | Transition screen from |
| | | lounge to office desk. |
| 2c3 | Thank you for the information relating to the use of Face Book. You have | An email from the ASA |
| | possibly saved the department from future embarrassment by staff inadver- | appears on your screen - |
| | tently doing the wrong things. | then opens out for you to |
| | We have not really looked into the impact of these sites as yet, however we | read |
| | will now be including it in all induction training and will be sending all | |
| | staff alert on the matter. Well done. | |
| 2c4 | Feedback: | |
| | This is the correct action. It is not appropriate to respond in any way on | |
| | the internet. By speaking to the ASA you will highlight an issue they may | |
| | not be aware of. Also, by speaking to your staff and other colleagues you | |
| | will be letting them know of the dangers of putting information out on the | |
| | internet. | |

Scenario 06: D. Discuss with your manager

| Scene ID | Content | Scene details |
|---|---|---|
| 2d1 | You discuss with your manager the fact when you were on Face Book you saw | |
| | a comment that could have repercussions for the department. You tell him | |
| | it related to a contract for the installation of CCTV equipment. | |
| 2d2 | You arrange a meeting with your manager . . . | Transition scene from |
| | | lounge room. |
| 2d3 | Back at your desk . . . | Transition scene from |
| | | manager's office. |
| 2d4 | Thank you for the information in relation to Face Book. This has enabled the | An email from the Senior |
| | Department to implement a new policy in relation to social networking sites. | Manger appears on your |
| | | screen - then opens out for |
| | | you to read |
| 2d5 | Feedback: | Scene: two people in an |
| | This is a good course of action. It allows the department the necessary infor- | office having a discussion. |
| | mation to intervene if necessary. | |

Scenario 07: Privacy Act

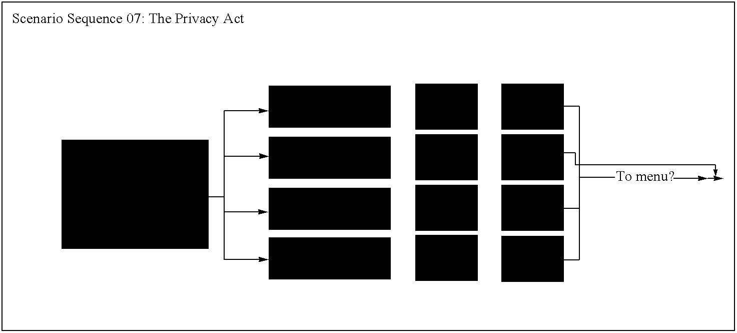

Scenario 07: Report containing sensitive personal information

| Scene ID | Content | Scene details |
|---|---|---|
| 2 | You are tasked to put together a report in relation to employee's age and | Scene: at your desk |
| | superannuation. This report holds sensitive personal information on a large | |
| | number of employee's. | |
| | While working on this report a national radio show discloses on their 9 am | |
| | news report that sensitive documents relating to superannuation were found | |
| | at a local recycling plant. | |
| | You believe this could be information you have worked on but you are certain | |
| | you would not have put the printouts in the recycle bin. | |
| | What do you do? | |
| | A. Do nothing | |
| | B. Discuss with your manager | |
| | C. Discuss with the media to find out more details | |
| | D. Discuss with a work colleague | |
| | Click each option to find out more then click SUBMIT to select your answer. | |

Scenario 07: A. Do nothing

| Scene ID | Content | Scene details |
|---|---|---|
| 2a1 | You know this information could not have come from you. You have been very | Scene: at your desk |
| | careful and put all your documents in the classified waste bin. | |
| 2a2 | It is found to be your report. The Department is named in the media | Scene: 3 people in an office - |
| | embarrassed. You fave a security investigation over your actions. | two on one side - one on |
| | | the other side of a desk. |
| | | Radio with bubble stating |
| | | “Department loses private |
| | | staff information” |
| 2a3 | Feedback: | |
| | This is not the right decision. While you may be confident in yourself you have | |
| | done the right thing, the department needs to be aware of the potential | |
| | embarrassment should it be found it was the report you were working on. | |

Scenario 07: B. Discuss with your manager

| Scene ID | Content | Scene details |
|---|---|---|
| 2b1 | You are certain in yourself this information could not have come from you as | Scene: in your office |
| | you have been very careful and put all your documents in the classified | |
| | waste bin. You decide to discuss it with your manager as he needs to know | |
| | that it is potentially your report. | |
| 2b2 | Your manager calls you into his office to let you know what has happened in | Scene: 2 people in an office |
| | regard to the information. An investigation revealed the classified waste bin | one is the State Manager |
| | was inadvertently delivered to the wrong plant and it was taken to the | |
| | recycle area plant instead of the classified waste area. | |
| | Your manager lets you know you have done the right thing by speaking up. | |
| 2b3 | Feedback: | Scene: 2 people in an office |
| | This is the best course of action as you have been open and upifont with your | |
| | manager and alerted him to a potential problem. | |

Scenario 07: C. Contact the media to find out more details

| Scene ID | Content | Scene details |
|---|---|---|
| 2c1 | While you are sure it is not your report, you are uneasy and want to find out a | Scene: in your office |
| | little more about this before going to management. You contact the ABC and | |
| | ask for more information. | |
| 2c2 | The Daily Advertiser - Lost Government Paperwork! | Scene: newspaper article |
| | You are quoted in a newspaper article which names your department. This | on ‘lost government |
| | triggers an investigation and consequently there is a loss of faith by the public | paperwork’ |
| | in your department's ability to handle private information. | |
| 2c3 | Feedback: | |
| | This is not the right course of action. No individual should speak to the media | |
| | unless sanctioned to do so. This could have far reaching consequences for your | |
| | department. | |

Scenario 07: D. Discuss with a work colleague

| Scene ID | Content | Scene details |
|---|---|---|
| 2d1 | While you are sure it is not you, you are unsure what to do. You hope a | Scene: in your office |
| | colleague will give you the right advice. | |
| 2c2 | An investigation was held into this matter and it revealed you had actually | Scene: in your office |
| | put the documents were working on in the recycle bin rather than the | |
| | classified waste bin. You have been issued with a formal notice of security | |
| | breach and are required to undergo further security awareness training. | |
| 2c3 | Feedback: | Scene: two people in an |
| | This is not the right course of action as your colleague may not direct you | office |
| | to your manager. While it may be helpful to talk it through with someone, | |
| | you should have gone directly to your manager. | |

Scenario 08: Looking over your shoulder

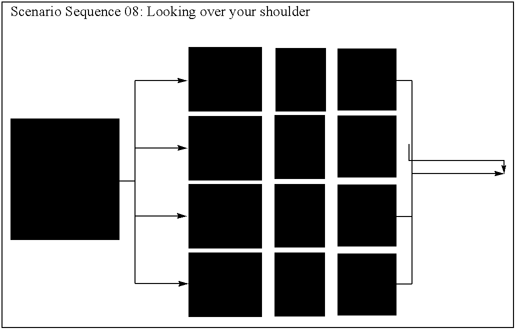

Scenario 08: Working on a document

| Scene ID | Content | Scene details |
|---|---|---|
| 2 | You are sitting at your desk working on | Scene: at your desk with |
| | sensitive or classified information. You | computer screen up with a |
| | have the computer screen open and files on | document on it. |
| | your desk. | |
| | The manager of another area arrives to | |
| | discuss some unrelated issue with you. | |
| | What do you do? | |
| | A. Close the document | |
| | B. Do nothing | |
| | C. Answer questions about the | |
| | document | |
| | D. Ask for assistance with an issue in | |
| | the document | |
| | Click each option to find out more then | |
| | click SUBMIT to select your answer. | |

Scenario 08: A. Close the document

| Scene ID | Content | Scene details |
|---|---|---|
| 2a1 | As you are aware the documents you are | Scene: normal computer |
| | working on are classified / sensitive you | screen with no open |
| | immediately close the computer screen and | document |
| | turn the documents over so they cannon be | |
| | read. | |
| 2a2 | Your manager comments on your good | Scene: two people in an |
| | security habits as he got feedback from the | office. |
| | other manager on how you handled the | |
| | situation. | |
| 2a3 | Feedback: | |
| | This is the correct action. Even if the | |
| | manager holds the correct level of | |
| | clearance, he has no ‘need to know’. | |

Scenario 08: B. Do nothing

| Scene ID | Content | Scene details |
|---|---|---|
| 2b1 | You elect to do nothing as the manager is of | Scene: office with computer |
| | a higher level than you and has a higher | screen up with document |
| | security clearance and as such should know | open |
| | what is going on in the section. | |
| 2b2 | You are called into your manager's office | Scene: office with two |
| | and he issues you with a security breach. | people having a discussion |
| | The other manager had passed on to him | |
| | your lack of security awareness in leaving a | |
| | classified document up on the computer | |
| | screen and documents on your desk that | |
| | were in easy view. | |
| 2b3 | Feedback: | |
| | This is not the right decision to make. | |
| | Regardless of the managers' clearance level | |
| | and higher position, you do not know he has | |
| | a need to know about the information you | |
| | are working on. | |

Scenario 08: C. Answer questions about the document

| Scene ID | Content | Scene details |
|---|---|---|
| 2c1 | When the manager who is senior to you and | Scene: office with computer |
| | holds the appropriate level clearance asks | screen up with document |
| | you what you are working on, you tell him | open |
| | and answer questions he asks you about the | |
| | project. | |
| 2c2 | You are called into your manager's office | Scene: office with two |
| | and he issues you with a security breach. | people having a discussion |
| | The other manager had passed on to him | |
| | your lack of security awareness in | |
| | discussing the project with him as he did not | |
| | have a ‘need to know’. | |
| 2c3 | Feedback: | |
| | This is incorrect. While he has the | |
| | appropriate level clearance he has no ‘need | |
| | to know’. You should have referred the | |
| | manager to the person you were working to | |
| | on the subject. | |

Scenario 08: D. Ask for assistance with an issue in the document

| Scene ID | Content | Scene details |
|---|---|---|
| 2d1 | You have hit a stumbling block just as the | Scene: office with computer |
| | manager approaches, as he has the right | screen up with document |
| | level clearance you ask him for advice | open |
| | while filling him in on the content of the | |
| | document. | |
| 2d2 | You are called into your manager's office | Scene: office with two |
| | and he issues you with a security breach | people having a discussion |
| | The other manager has spoken to all and | |
| | sundry about the project you were working | |
| | on and there is gossip all over the section as | |
| | to what the project is actually about. | |
| 2d3 | Feedback: | |
| | This is not the right course of action. Even | |
| | though you knew he had the right level of | |
| | clearance you did not know if he had a need | |
| | to know about the documents. You have | |
| | breached the confidentiality of the | |
| | documents and security in discussing this | |
| | with him. | |

Scenario 09: Visitor to building

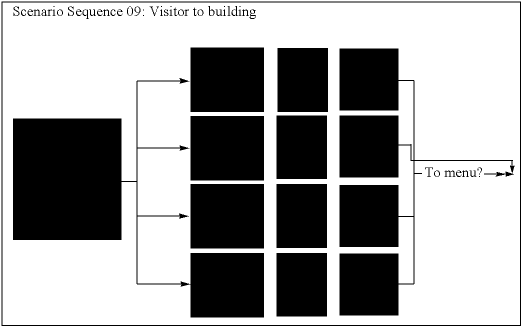

Scenario 09: Escorted visitor

| Scene ID | Content | Scene details |
|---|---|---|
| 2 | An ex-colleague, who is now contracting to | Scene: front guard desk |
| | your area requires you to sign them in as an | with two people signing |
| | ‘escorted visitor’. This person knows many | register |
| | people in the department as they previously | |
| | worked in the area. They want to catch-up | |
| | for coffee with a couple of their | |
| | acquaintances. | |
| | What do you do? | |
| | A. Escort them to the coffee shop | |
| | B. Drop them at the coffee shop | |
| | C. Tell them to go to the coffee shop to | |
| | catch up with their friends without | |
| | you | |
| | D. Escort and leave | |
| | Click each option to find out more then | |
| | click SUBMIT to select your answer. | |

Scenario 08: A. Escort them to the coffee shop

| Scene ID | Content | Scene details |
|---|---|---|
| 2a1 | As they are an ‘escorted visitor’ you know it | Scene: front guard desk with |
| | is your responsibility to escort them while | two people signing register |
| | they are on the premises or have someone | |
| | else sign over as their escort. | |
| 2a2 | There is not consequence other than you | Scene: coffee shop with a |
| | had done your job and fulfilled your | number of people inside |
| | security responsibilities by escorting the | |
| | person to the coffee shop | |
| 2a3 | Feedback: | |
| | This is correct decision. In Secure and | |
| | Partially Secure Areas, all visitors must be | |
| | escorted at all times. In other areas, | |
| | agencies should consider the benefits of | |
| | visitors being escorted at all times. | |

Scenario 08: B. Drop them at the coffee shop

| Scene ID | Content | Scene details |
|---|---|---|
| 2b1 | As they have a lot of contacts you escort | Scene: front guard desk with |
| | them to the coffee shop. You have more | two people signing register |
| | work to do so you ensure one of their | |
| | friends escorts them back to the office. | |
| 2b2 | There is not consequence other than you | Scene: coffee shop with a |
| | had done your job and fulfilled your | number of people inside |
| | security responsibilities by escorting the | |
| | person to the coffee shop and ensuring there | |
| | is another staff member to return them to | |
| | the work area. | |
| 2b3 | Feedback: | |
| | This is the right decision. By ensuring the | |
| | visitor is escorted at all times is complying | |
| | with the PSM. | |

Scenario 08: C. Tell them to go to the coffee shop
to catch up with their friends without you

| Scene ID | Content | Scene details |
|---|---|---|
| 2c1 | You are very busy and as they have | Scene: front guard desk with |
| | previously worked for the department and | two people signing register |
| | are meeting past colleagues you let them | |
| | make their own way to the coffee shop | |
| | unescorted. | |
| 2c2 | You are called into the ASA's office to | Scene: two people in an |
| | answer questions regarding the contractor | office. You are being asked |
| | you did not escort as required. It has | to explain . . . |
| | become apparent the contractor managed to | |
| | read some information on their way out that | |
| | gave them a competitive edge in a tendering | |
| | process. This in turn compromised the | |
| | tendering process costing the department | |
| | $millions. | |
| | You are subsequently issued with a security | |
| | breach and you need to give cause as to why | |
| | you should not have your clearance | |
| | suspended. | |
| 2c3 | Feedback: | |
| | This is not the right decision as the PSM | |
| | and your security instructions clearly state | |
| | visitors should be escorted at all times while | |
| | in the buildin. | |

Scenario 08: D. Escort and leave

| Scene ID | Content | Scene details |
|---|---|---|
| 2d1 | You escort the contractor to the coffee | Scene: front guard desk with |
| | lounge and leave him to find his own way | two people signing register |
| | back. | |
| 2d2 | You are called into the ASA's office to | Scene: two people in an |
| | answer questions regarding the contractor | office. You are being asked |
| | you did not escort as required. It has | to explain |
| | become apparent the contractor managed to | |
| | read some information on their way out that | |
| | gave them a competitive edge in a tendering | |
| | process. This in turn compromised the | |
| | tendering process costing the department | |
| | $millions. | |
| | You are subsequently issued with a security | |
| | breach and you need to give cause as to why | |
| | you should not have your clearance | |
| | suspended. | |
| 2d3 | Feedback: | Scene: coffee shop with a |
| | This is not the right decision as the PSM | number of people at tables. |
| | and your security instructions clearly state | |
| | visitors should be escorted at all times while | |
| | in the building. | |

Scenario 10: Clearance

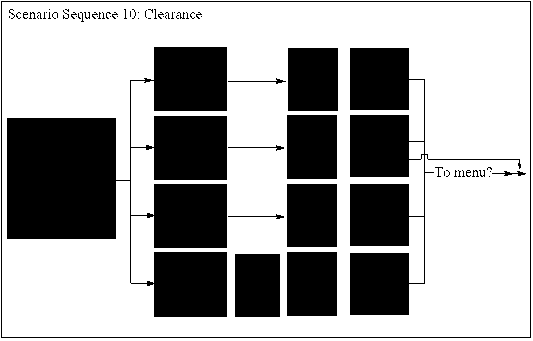

Scenario 10: New security pack

| Scene ID | Content | Scene details |
|---|---|---|
| 2 | You have to fill in a new security pack. | Scene: at your desk with |
| | While doing so there is a question you have | documents on your desk |
| | to answer in the affirmative. You believe | |
| | this honesty will cause you some degree of | |
| | difficulty during the process. | |
| | You know of other people who have been | |
| | truthful and were not successful in gaining | |
| | their security clearance. You are also aware | |
| | some others have lied and not been ‘found | |
| | out’. | |
| | What do you do? | |
| | A. Withhold the information | |
| | B. Partially answer | |
| | C. Don't answer | |
| | D. Answer honestly | |
| | Click each option to find out more then | |
| | click SUBMIT to select your answer. | |

Scenario 10: A. Withhold the information

| Scene ID | Content | Scene details |
|---|---|---|
| 2a1 | You believe being honest will cause a | Scene: at your desk with |
| | problem so you elect to not disclose the | documents on your desk |
| | information. | |
| 2a2 | Due to your security clearance being denied | Scene: letter on desk - |
| | you are hereby notified of your transfer to a | opens to read |
| | position not requiring a security clearance. | |
| | As of Monday 3^{rd} you are required to report | |
| | to the Manager Industrial Waste. | |
| 2a3 | Feedback: | |
| | This is the wrong thing to do. Once | |
| | dishonesty or withholding information | |
| | becomes apparent in the clearance process | |
| | you can be assessed negatively against the | |
| | factor areas of honesty, maturity, | |
| | trustworthiness, tolerance and loyalty. | |

Scenario 10: B. Partially answer

| Scene ID | Content | Scene details |
|---|---|---|
| 2b1 | You believe being honest will cause a | Scene: at your desk with |
| | problem so you elect to not disclose all the | documents on your desk |
| | relevant information. | |
| 2b2 | Due to your security clearance being denied | Scene: letter on desk - |
| | you are hereby notified of your transfer to a | opens to read |
| | position not requiring a security clearance. | |
| | As of Monday 3^{rd} you are required to report | |
| | to the Manager Industrial Waste. | |
| 2b3 | Feedback: | |
| | This is the wrong thing to do. Once | |
| | dishonesty or withholding information | |
| | becomes apparent in the clearance process | |
| | you can be assessed negatively against the | |
| | factor areas of honesty, maturity, | |
| | trustworthiness, tolerance and loyalty. | |

Scenario 10: C. Don't answer

| Scene ID | Content | Scene details |
|---|---|---|
| 2c1 | You believe being honest will cause a | Scene: at your desk with |
| | problem so you decide to leave the question | documents on your desk |
| | blank and hope it doesn't get picked up. | |
| 2c2 | Due to your security clearance being denied | Scene: letter on desk - |
| | you are hereby notified of your transfer to a | opens to read |
| | position not requiring a security clearance. | |
| | As of Monday 3^{rd} you are required to report | |
| | to the Manager Industrial Waste. | |
| 2c3 | Feedback: | |
| | This is the wrong thing to do. Once | |
| | dishonesty or withholding information | |
| | becomes apparent in the clearance process | |
| | you can be assessed negatively against the | |
| | factor areas of honesty, maturity, | |
| | trustworthiness, tolerance and loyalty. | |

Scenario 10: D. Answer honestly

| Scene ID | Content | Scene details |
|---|---|---|
| 2d1 | You know the security clearance process is | Scene: at your desk with |
| | a serious matter and you answer all | documents on your desk |
| | questions frilly and honestly. You decide if | |
| | this creates problems for your clearance you | |
| | have done the right thing and not withheld | |
| | information or lied. | |
| 2d2 | The case officer handling your security file | Scene: on the phone in your |
| | calls you to clarify the information you have | office (to the ASA) |
| | provided on your security forms. He invites | |
| | you to meet with him to discuss the issues | |
| | so as your clearance process can proceed. | |
| | He assures you there is no need to worry as | |
| | you have been honest and upfront by | |
| | supplying the information. | |
| 2d3 | Your security clearance has been granted | Scene: letter on desk - |
| | with a proviso of aftercare to address the | opens to read |
| | area of concern raised by your previous | |
| | behaviour. You are happy your clearance | |
| | has been finalised and know you have done | |
| | the right thing. | |
| 2d4 | Feedback: | |
| | This is the right decision. You may think | |
| | the information will be detrimental to your | |
| | clearance, however it may turn out not to be | |
| | an issue at all. As a Public Servant you are | |
| | required to perform your duties with the | |
| | highest level of ethics and accountability | |
| | and are required to meet the requirements of | |
| | the PSM should you need to hold a security | |
| | clearance. | |

Scenario 11: Wearing ID cards

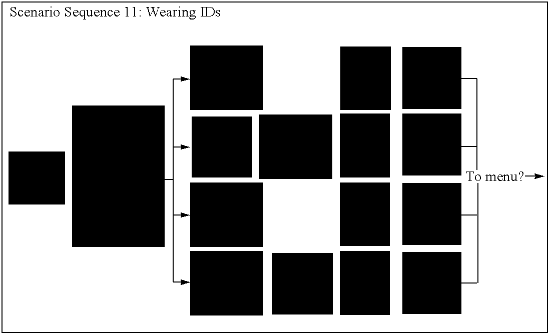

Scenario 11: Security update

| Scene ID | Content | Scene details |
|---|---|---|
| 1 | From: Agency/IT Security Adviser | Arrives on desk as an email |
| | Title: Security Update | flashing on the computer |
| | All staff are reminded of the need to wear | screen. Can be saved for |
| | their Identification Cards at all times. Cards | later or deleted |
| | are to be worn on the waist or around your | |
| | neck facing outwards so you are easily | |
| | identifiable. | |
| | Id's are not to be worn around your neck | |
| | with the card placed in your shirt pocket. | |

Scenario 11: Wearing your identification

| Scene ID | Content | Scene details |
|---|---|---|
| 2 | You notice while going to lunch a group of | Scene: lift area in building |
| | people talking, none of whom are wearing | behind the security barriers |
| | Departmental ID cards. | |
| | You know the instruction went out advising | |
| | staff to wear their id's at all times. | |
| | What do you do? | |
| | E. Do nothing | |
| | F. Ask for ID cards | |
| | G. Call security | |
| | H. Advise your manager when you | |
| | return from lunch | |
| | Click each option to find out more then | |
| | click SUBMIT to select our answer. | |

Scenario 11: A. Do nothing

| Scene ID | Content | Scene details |
|---|---|---|
| 2a1 | You decide it is not up to you to say | Scene: person walking out |
| | anything to them, so head on out for lunch. | of the building |
| 2a2 | Headline: Protest held in Government | Scene: headline of a |
| | Department | newspaper flies into the |
| | Protestors gain access to government | screen over your desk |
| | building in the city. | |
| | The individuals were not staff members but | |
| | a group of protestors who gained access to | |
| | the building. | |
| 2a3 | Feedback: | |
| | This is not the right course of action. The | |
| | All Staff notice was quite explicit and you | |
| | should have taken some action to check if | |
| | they had ID cards. Your options should | |
| | have been either asking them for their ID | |
| | cards or getting one of the Security staff to | |
| | speak to them. | |

Scenario 11: B. Ask for ID cards

| Scene ID | Content | Scene details |
|---|---|---|
| 2b1 | You go to back through to the lifts . . . | Scene: transition |
| 2b2 | You approach the group and ask to see their | Scene: group of people at |
| | ID cards. They all apologise and produce | the lifts. |
| | them for you. One of the groups says, | |
| | ‘we're all new and didn't know we had to | |
| | wear them’. | |
| 2b3 | I hear you ensured the graduate group were | Scene: email from the ASA |
| | aware of the requirement to wear their ID | appears on your screen and |
| | cards at all times. Thanks for taking the | opens up to read |
| | time to explain it to them. They had been | |
| | told, but obviously needed to be reminded. | |
| | I wish more staff were willing to take | |
| | responsibility for these types of things. | |
| 2b4 | Feedback: | |
| | This is the right decision as you have made | |
| | sure they are staff and have the correct ID | |
| | cards. | |

Scenario 11: C. Call security

| Scene ID | Content | Scene details |
|---|---|---|
| 2c1 | You use the nearest phone and let security | Scene: person on the phone |
| | know there is a group of people at the lifts | |
| | without ID cards as you do not feel | |
| | comfortable challenging such a large group | |
| | you do not know. | |
| 2c2 | Thank you for referring the group of people | Scene: email from the ASA |
| | earlier who were not wearing their ID cards. | appears on your screen and |
| | They were our new graduate group and | opens up to read |
| | were not aware they had to wear their ID | |
| | cards at all times. I wish more staff were | |
| | willing to take responsibility for these types | |
| | of things. | |
| 2c3 | Feedback: | |
| | This is a good decision as while you may | |
| | not feel comfortable challenging a group of | |
| | people you do not know; you have let the | |
| | Security people know who can then deal | |
| | with the situation. | |

Scenario 11: D. Advise your manager when you return from lunch

| Scene ID | Content | Scene details |
|---|---|---|
| 2d1 | You are running late meeting your friends | |
| | for lunch so decide to let the manager know | |
| | when you return. | |
| 2d2 | When you return from lunch, you find the | Scene: transition |
| | building is shut down as there is a group of | |
| | protestors refusing to leave. It seems they | |
| | gained access an hour ago and nobody | |
| | checked on who they were | |
| 2d3 | When you return from lunch, you find the | Scene: front of building |
| | building is shut down as there is a group of | with people denied access |
| | protestors refusing to leave. It seems they | |
| | gained access an hour ago and nobody | |
| | checked on who they were. | |
| 2d4 | You feel responsible for the protestors | Scene: 3 people in an office |
| | gaining access and speak to your manager | |
| | when you are able to return to your work | |
| | area. He agrees you should have asked for | |
| | ID or advised the Security staff who could | |
| | have dealt with the issue earlier. The ASA | |
| | speaks to you and lets you know you | |
| | weren't the only one not to challenge them | |
| | and thanks you for being honest and letting | |
| | them know you had seen them. There is no | |
| | further action taken in this instance. | |
| 2d5 | Feedback: | |
| | This was not the right decision as you did | |
| | not know they if they were staff members. | |
| | They could have been anyone trying to gain | |
| | access to the building. | |

Scenario 12: Transport of documents

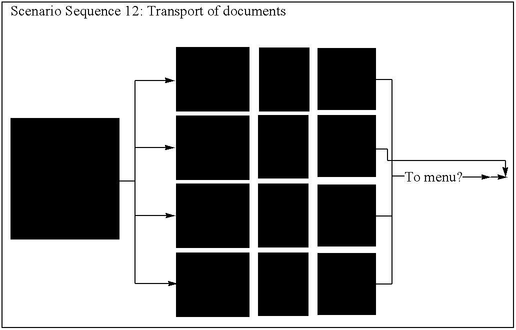

Scenario 12: Documents to be transported

| Scene ID | Content | Scene details |
|---|---|---|
| 2 | Your manager has asked you to send a | Scene: office scene with |
| | sensitive document to one of your interstate | documents on desk. |
| | managers. | |
| | What do you do? | |
| | I. Post it | |
| | J. Read the PSM (i.e. manual) | |
| | K. Refer to security | |
| | L. Fax the document | |
| | Click each option to find out more then | |
| | click SUBMIT to select your answer. | |

Scenario 12: A. Post it

| Scene ID | Content | Scene details |
|---|---|---|
| 2a1 | You know the documents are urgent so you | Scene: normal envelope |
| | immediately put in an envelope and send it. | sitting in mail tray |
| 2a2 | Consequence | Scene: front page of paper |
| | Government information | over desk scene. |
| | Government Department loses more official | |
| | information. | |
| | As a result of posting the document it has | |
| | inadvertently been lost in the post and | |
| | ended up in the hands of a local journalist. | |
| | Once again the public has lost faith with | |
| | your department. | |
| 2a3 | Feedback: | |
| | This is not the right course of action. To | |
| | send sensitive or classified information | |
| | there are specific instructions. Prior to | |
| | sending information you should ensure you | |
| | check the PSM for the correct way to | |
| | transport or transmit information. | |

Scenario 12: B. Read the PSM

| Scene ID | Content | Scene details |
|---|---|---|
| 2b1 | You have no idea how you send the | Scene: person at desk with |
| | document so you check the PSM to find out | document open on computer |
| | what you should do. | screen. |
| 2b2 | Consequence: document is received | Scene: outside in park |
| | You are at lunch and your mobile rings. It | person on mobile |
| | is the manger you sent the document to | |
| | letting you know it arrived safely. | |
| 2b3 | Feedback: | |
| | This is very good decision. While you do | |
| | not need to know everything in the PSM it | |
| | is good practice to make yourself familiar | |
| | with the parts concerning the security of | |
| | information. | |

Scenario 12: C. Refer to security

| Scene ID | Content | Scene details |
|---|---|---|
| 2c1 | You are not sure what to do so you go | Scene: 2 people at a desk |
| | around to the Security section to find out. | having a discussion. |
| 2c2 | Consequence: document is received | Scene: outside in park, |
| | You are at lunch and your mobile rings. It | person on mobile |
| | is the manger you sent the document to | |
| | letting you know it arrived safely. | |
| 2c3 | Feedback: | |
| | This is a great decision. As you don't know | |
| | the best thing to do is find out from the | |
| | experts. | |

Scenario 12: D. Fax the document

| Scene ID | Content | Scene details |
|---|---|---|
| 2d1 | You decide the simplest way to send the | Scene: person at fax |
| | document is to fax it through. | machine |
| 2d2 | Consequence | Scene: front page of paper |
| | Government information | over desk scene. |
| | Government Department loses more official | |
| | information. | |
| | As a result of faxing the document it has | |
| | inadvertently been sent to the wrong fax | |
| | number and passed on to the media. Once | |
| | again the public has lost faith with your | |
| | department. | |
| 2d3 | Feedback; | |
| | This is not the right course of action. To | |
| | send sensitive or classified information | |
| | there are specific instructions. Prior to | |
| | sending information you should ensure you | |
| | check the PSM for the correct way to | |
| | transport or transmit information. | |

Scenario 13: Home based work

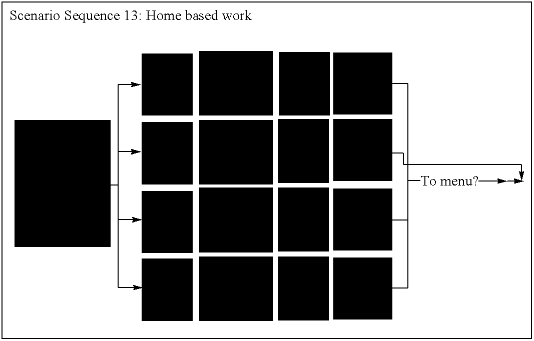

Scenario 13: Home based work

| Scene ID | Content | Scene details |
|---|---|---|
| 2 | One of your staff is convalescing from a | Scene: At your desk. |
| | work related injury. Part of their return to | |
| | work program means they are working from | |
| | home two days a week. Their position | |
| | requires then to handle and refer to sensitive/ | |
| | classified information in the course of their | |
| | duties. | |
| | What do you do to ensure they adhere to the | |
| | home based work policy and procedures? | |
| | M. Do nothing | |
| | N. Discuss with the ASA | |
| | O. Undertake an assessment of the | |
| | home | |
| | P. Ask the employee to complete their | |
| | own assessment | |
| | Click each option to find out more then | |
| | click SUBMIT to select your answer. | |

Scenario 13: A. Do nothing

| Scene ID | Content | Scene details |
|---|---|---|
| 2a1 | You go to get a coffee. | Scene: transition |
| 2a2 | They are a trusted employee who knows | Scene: coffee shop |
| | what they are doing so you decide there is | |
| | nothing you need to do. | |
| 2a3 | The house has been burgled and the | Scene: letter arrives on your |
| | documents your staff member was working | desk and opens out |
| | on have been taken. | |
| | A Ministerial arrives on your desk asking | |
| | ‘please explain’ after the documents were | |
| | posted to the Minister's office after being | |
| | found in a park. | |
| 2a4 | Feedback: | |
| | This is not the right decision. There are | |
| | requirements set out in the PSM referring to | |
| | home based work you should ensure have | |
| | been met. | |

Scenario 13: B. Discuss with the ASA

| Scene ID | Content | Scene details |
|---|---|---|
| 2b1 | You go to visit the ASA | Scene: transition |
| 2b2 | You ask the ASA for advice on what is | Scene: 2 people speaking at |
| | required before you staff member can begin | workstation. |
| | their home based work. | |
| 2b3 | Consequence | Scene: email arrives and |
| | Well done handling Dave's home based | opens up to read |
| | work requirements. The ASA let me know | |
| | you sought advice and Dave is now set up | |
| | and ready to go. | |
| 2b4 | Feedback: | |
| | This is the correct decision. The ASA is | |
| | responsible for ensuring all home based | |
| | work is approved and meets the | |
| | requirements set out in the PSM. | |

Scenario 13: C. Undertake an assessment of the home

| Scene ID | Content | Scene details |
|---|---|---|
| 2c1 | You go to the home office . . . | Scene: transition |
| 2c2 | You decide to go around and do an | Scene: study in a house |
| | assessment on the house to make sure there | |
| | are no security issues. | |
| 2c3 | Consequence | Scene: email arrives and |
| | I understand you gave permission for one of | opens up |
| | your staff to undertake home based work. I | |
| | have been notified by one our staff | |
| | members the home office does not meet the | |
| | requirements under the PSM. I will need to | |
| | discuss this matter with you fUrther, can you | |
| | please meet with me this afternoon at 2 pm | |
| | to discuss this breach of security. | |
| 2c4 | Feedback: | |
| | While there is a need for an assessment to | |
| | take place, it is not your responsibility to | |
| | undertake it. The ASA is the person who is | |
| | responsible. | |

Scenario 13: D. Ask the employee to do their own assessment

| Scene ID | Content | Scene details |
|---|---|---|
| 2d1 | At the home office . . . | Scene: transition |
| 2d2 | You decide your employee will know what | Scene: home office |
| | they need to do so have them assess their | |
| | home office and report back to you. | |
| 2d3 | Consequence | Scene: letter arrives on your |
| | The house has been burgled and the | desk and opens out |
| | documents your staff member was working | |
| | on have been taken. | |
| | A Ministerial arrives on your desk asking | |
| | ‘please explain’ after the documents were | |
| | posted to the Minister's office after being | |
| | found in a park. | |
| 2d4 | Feedback: | |
| | This is not the right decision. There are | |
| | requirements set out in the PSM referring to | |
| | home based work you should ensure have | |
| | been met. | |

Scenario 14: End of day procedures

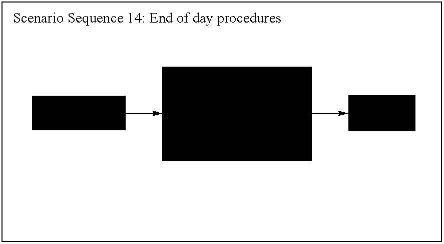

Scenario 14: Instructions

| Scene ID | Content | Scene details |
|---|---|---|
| 1 | You need to attend an event that will | Scene: At your desk |
| | go to the end of the day! | An email comes up |
| | Complete your end of day procedures | instructing you to |
| | and head down to level 12. | perform the end of |
| | See you there! | day procedures. |

Scenario 14: Perform end of day procedures

| Scene ID | Content | Scene details |
|---|---|---|
| 2 | Use the mouse to check for items | Scene: At your desk |
| | that must be dealt with. When you | The desk scene |
| | have to do something, some information | shows any items |
| | is displayed as a rollover. Click the | such as keys, etc |
| | active area to perform the end of day | removed as you |
| | procedure. | complete the action. |
| | 1. Log off your computer and shut | |
| | down | |
| | 2. Place Security Files into security | |
| | containers and lock correctly. | |
| | 3. Place normal files into filing cabinet | |
| | and lock. | |
| | 4. Remove keys and put in key safe. | |
| | 5. Clear desk of any papers and sticky | |
| | notes. | |
| | 6. Put unwanted paper in the recycle | |
| | bin. | |
| | 7. Check fax/photocopier for any | |
| | papers. | |
| | Click to complete the action. | |

Scenario 14: Free to go

| Scene ID | Content | Scene details |
|---|---|---|
| 2 | Your desk is now secured. You may | Scene: At your desk |
| | leave. | The desk scene now |
| | | shows any items |
| | | such as keys, etc |
| | | removed. |

Scenario 15: Assessment

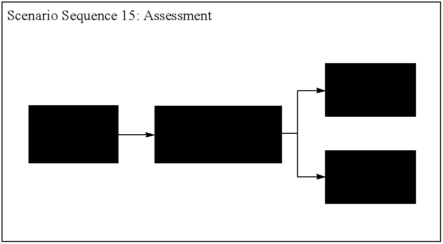

Scenario 15: Assessment Instructions

| Scene ID | Content | Scene details |
|---|---|---|
| 1 | Answer each of the questions by | |
| | placing the correct sticky tab on the | |
| | square. | |
| | Your aim is to progress though the | |
| | grid and get safely to the office. | |
| | For each wrong answer, your sticky | |
| | tab will go back to the answer grid. | |
| | For each right answer the next | |
| | question will then be available. | |
| | Once you have successfully | |
| | completed the assessment, you will | |
| | receive a certificate! | |

Scenario 15: Assessment

| Scene ID | Content | Scene details |
|---|---|---|
| 2 and 2a | Questions: (target area) | Interaction: drag and |
| | 1. What is appropriate to discuss | drop. |
| | on Facebook? | Scene: assessment |
| | 2. What policy should you adhere | scene. |
| | to at the end of the day? | Answers to be |
| | 3. What is the clear desk policy? | randomised. |
| | 4. What is the ASA | |
| | 5. What is the PSM | |
| | 6. What is ‘Need to Know’? | |
| | 7. To read a SECRET document | |
| | what clearance must you have? | |
| | 8. How should your security pass | |
| | be displayed? | |
| | 9. What are the National level | |
| | classifications? | |
| | 10. How do you travel with a | |
| | classified file interstate? | |
| | 11. Releasing classified or | |
| | sensitive departmental information | |
| | could cause harm for who? | |
| | Answers: | |
| | 1. It is not appropriate to discuss | |
| | anything relating to your work, | |
| | including where you work. | |
| | 2. Clear desk policy | |
| | 3. Your desk is cleared any time | |
| | you are not at it, particularly at | |
| | the end of the day. | |
| | 4. Agency Security Adviser | |
| | 5. The Protective Security Manual | |
| | (2005) | |
| | 6. The availability of information | |
| | should be limited to those who | |
| | need to use or access the infor- | |
| | mation to do their work. | |
| | Dissemination of information | |
| | should be no wider than is required | |
| | for the efficient conduct of the | |
| | business at hand. | |
| | 7. SECRET or TOP SECRET | |
| | clearances allow you to read a | |
| | SECRET document as long as you | |
| | have a ‘need to know’ | |
| | 8. In plain view face outwards. | |
| | 9. Restricted (used by Defence), | |
| | Confidential, Secret and Top | |
| | Secret | |
| | 10. Using a SCEC endorsed | |
| | briefcase. | |
| | 11. Federal, State or Territory | |
| | governments and the department. | |
| 3 | This certificate is awarded to: | Scene: Certificate with |
| | {First name} {Last name} | learners details, able to |
| | For successful completion of | be printed |
| | . . . | |
| | Dated: dd/mm/yyyy | |

1. A method of providing scenario based training or assessment of a user, the method performed on a processing system and including the steps of:
providing the user with scenario information about a scenario;
providing the user with a question and a plurality of answers;
receiving a selected answer, the selected answer being selected from the plurality of answers by the user; and,
providing the user with consequence information based on the selected answer.

2. The method as claimed in claim 1, wherein the user is additionally provided with feedback.

3. The method as claimed in claim 1, wherein the user is initially provided with background information about the scenario.

4. The method as claimed in claim 1, wherein the scenario information is provided as one or a combination of image, video, text or audio information.

5. The method as claimed in claim 1, wherein the scenario information includes dialog associated with an image of a human role-playing character displayed to the user.

6. The method as claimed in claim 1, wherein each of the plurality of answers has associated consequence information.

7. The method as claimed in claim 1, wherein the consequence information is provided as one or a combination of image, video, text or audio information.

8. The method as claimed in claim 1, wherein the consequence information mimics a real-life potential consequence if the user had followed the selected answer in practice.

9. The method as claimed in claim 1, further including providing the user with a sequence of different scenarios, each different scenario including scenario information, a question, a plurality of answers and associated consequence information based on the answers.

10. The method as claimed in claim 9, wherein the scenarios are provided to the user as an ordered series of scenarios or are randomly determined.

11. The method as claimed in claim 9, wherein if a user selected answer in a particular scenario is determined to be incorrect, the sequence of different scenarios loops back to the particular scenario at a later point in time.

12. The method as claimed in claim 11, wherein the particular scenario is again provided to the user but the user selected answer in the particular scenario that was determined to be incorrect is removed.

13. The method as claimed in claim 1, wherein the user is required to provide a unique identifier code.

14. The method as claimed in claim 1, wherein after a predetermined number of scenarios are completed notification of completion is provided to a nominated person or section.

15. A system for providing scenario based training or assessment of a user, the system including:
an output device to provide the user with scenario information and to provide the user with a question and a plurality of answers;
an input device to receive a selected answer, the selected answer being selected from the plurality of answers by the user; and,
wherein, the output device provides the user with consequence information determined by at least one processor based on the selected answer.

16. A computer program product for providing scenario based training or assessment of a user, the computer program product able to be executed on a processing system and to:
provide the user with scenario information;
provide the user with a question and a plurality of answers;
receive a selected answer, the selected answer being selected from the plurality of answers by the user; and,
provide the user with consequence information based on the selected answer.

17. The computer program product as claimed in claim 16, where the computer program product is a training simulator.

18. The computer program product as claimed in claim 16, including a display screen provided to the user including a plurality of user selectable icons to allow the user to access global help, display an overview of total scenario progress, save the user's current position, or exit the current scenario training.
